(19) United States
(12) Patent Application Publication
(10) Pub. No.: US 2026/0301543 A1
(43) Pub. Date: Oct. 1, 2026

(54) SYSTEMS AND METHODS FOR GENERATING AND PROVIDING SHARED BONUS FEATURES IN ELECTRONIC WAGERING GAMES

(71) Applicant: Aristocrat Technologies, Inc., Las Vegas, NV (US)

(72) Inventors: Timothy Smith, Spring Hill, TN (US); Chad Evans, Murfreesboro, TN (US)

(21) Appl. No.: 19/097,696

(22) Filed: Apr. 1, 2025

(51) Int. Cl. G07F 17/32

(52) U.S. Cl. CPC G07F 17/3281; G07F 17/323; G07F 17/3258; G07F 17/3267

(57) ABSTRACT

A system may include multiple EGMs arranged in banks, a wide area ball call server, a bonus mode server, a communications network, and a gaming network. The bonus mode server receives a communication from an EGM at a first bank of EGMs indicating that the EGM has entered a bonus mode according to a ball drop. The bonus mode is open to receiving additional players. The bonus mode server may also generate a control signal for another EGM to present an indication to other potential players that the shared bonus mode on the first EGM is open to receiving additional players for a limited amount of time. The bonus mode server provides the generated control signal to other EGM, determines that the other EGM has received a buy-in from a player, and incorporates the other EGM into the shared bonus mode. Various other computer-readable media and methods are also disclosed.

### BACKGROUND

Electronic gaming machines (“EGMs”) or gaming devices provide a variety of wagering games such as slot games, video poker games, video blackjack games, roulette games, video bingo games, keno games and other types of games that are frequently offered at casinos and other locations. Play on EGMs typically involves a player establishing a credit balance by inputting money, or another form of monetary credit, and placing a monetary wager (from the credit balance) on one or more outcomes of an instance (or single play) of a primary or base game. In some cases, a player may qualify for a special mode of the base game, a secondary game, or a bonus round of the base game by attaining a certain winning combination or triggering event in, or related to, the base game, or after the player is randomly awarded the special mode, secondary game, or bonus round. In the special mode, secondary game, or bonus round, the player is given an opportunity to win extra game credits, game tokens or other forms of payout. In the case of “game credits” that are awarded during play, the game credits are typically added to a credit meter total on the EGM and can be provided to the player upon completion of a gaming session or when the player wants to “cash out.”

“Slot” type games are often displayed to the player in the form of various symbols arrayed in a row-by-column grid or matrix. Specific matching combinations of symbols along predetermined paths (or paylines) through the matrix indicate the outcome of the game. The display typically highlights winning combinations/outcomes for identification by the player. Matching combinations and their corresponding awards are usually shown in a “pay table” which is available to the player for reference. Often, the player may vary his/her wager to include differing numbers of paylines and/or the amount bet on each line. By varying the wager, the player may sometimes alter the frequency or number of winning combinations, frequency or number of secondary games, and/or the amount awarded.

Casinos and other gaming establishments typically have multiple different types of electronic wagering games. Some of these games include Class III games, which include traditional slot type games or matching games. Typical games use a random number generator (RNG) to randomly determine the outcome of each game. The game is designed to return a certain percentage of the amount wagered back to the player over the course of many plays or instances of the game, which is generally referred to as return to player (RTP). The RTP and randomness of the RNG ensure the fairness of the games and are highly regulated. Upon initiation of play, the RNG randomly determines a game outcome, and symbols are then selected which correspond to that outcome. Notably, some games may include an element of skill on the part of the player and are therefore not entirely random.

### SUMMARY

As will be described in greater detail below, the instant disclosure generally relates to systems and methods for generating and providing shared bonus features or shared bonus games in electronic wagering games. In some embodiments, an electronic gaming system may be provided that includes multiple electronic gaming machines arranged in banks, a wide area ball call server communicatively linked to the EGMs, a bonus mode server communicatively linked to the EGMs, a communications network that communicatively links the wide area ball call server to multiple Class II game servers, and a gaming network that communicatively links the Class II game servers to the EGM banks.

The bonus mode server may receive, via the gaming network, a communication from a first EGM of a first bank of EGMs indicating that the first EGM has entered a bonus mode according to a ball drop generated by the wide area ball call server. The bonus mode is open to receiving additional players to increase a prize amount of a shared bonus mode prize. The bonus mode server may also generate a control signal for at least a second EGM to present an indication to other potential players that the shared bonus mode on the first EGM is open to receiving additional players for a limited amount of time. The bonus mode server may further provide the generated control signal to at least the second EGM, so that the second EGM will notify other potential players that the shared bonus mode is currently available. The bonus mode server may also determine that the second EGM has received a buy-in from a player before the limited amount of time has expired, and may then incorporate the second EGM into the shared bonus mode, so that players at both the first EGM and the second EGM are eligible to win the shared bonus mode prize.

In some examples, wherein the shared bonus mode is entered upon reaching a triggering condition in a base Class II electronic wagering game. In some cases, the shared bonus mode prize is paid to a single winner after an end condition to the base Class II electronic wagering game has been reached. In some embodiments, at least part of the shared bonus mode prize is paid to a first player and at least part of the shared bonus mode prize is paid to a second player upon reaching an end condition to the base Class II electronic wagering game. In some cases, the base Class II electronic wagering game is designed based on a specified theme, and wherein the shared bonus mode follows the specified theme of the base Class II electronic wagering game.

In some embodiments, the base Class II electronic wagering game is designed based on a specified theme, and wherein the shared bonus mode follows a different theme than the specified theme of the base Class II electronic wagering game. In such cases, a prize amount associated with the shared bonus mode prize is increased when a player that triggered the shared bonus mode wins the shared bonus mode. In some examples, a prize amount associated with the shared bonus mode prize is based on how many players have bought in when the shared bonus mode ends. In some cases, a prize amount associated with the shared bonus mode prize is determined based on a Class II pay table. In such cases, the plurality of EGMs includes multiple different banks of EGMs. In some embodiments, the different banks of EGMs are located in different parts of a casino.

In some examples, each of the EGMs in the plurality of EGMs is controlled by the wide area ball call server using control signals transmitted over the secure communications network. In some embodiments, one or more EGMs are dynamically added to at least one of the banks of EGMs, and wherein the added EGMs are controlled by the wide area ball call server. In some cases, the shared bonus mode is open to a limited, specified number of additional players. In some embodiments, the limited number of additional players is dynamically expanded to include further players upon the occurrence of one or more specified conditions.

In some examples, a prize amount of the shared bonus mode prize increases incrementally each time a subsequent player buys in to the shared bonus mode on another EGM. In some cases, players that subsequently join the shared bonus mode stay eligible for the payout amount upon providing one or more subsequent buy-ins. In some examples, the bonus mode server may further send a control signal to a display mounted above at least a portion of the first EGM to present a notification indicating that the shared bonus mode is available to join, where the notification provides a timer indicating a time by which players are to buy in in order to participate in the shared bonus mode.

In addition to the electronic gaming system described above, a corresponding computer-implemented method may be provided. The method includes receiving, via a gaming network, a communication from a first EGM of a first bank of EGMs indicating that the first EGM has entered a bonus mode according to a ball drop generated by a wide area ball call server, wherein the bonus mode is open to receiving additional players to increase a prize amount of a shared bonus mode prize, generating a control signal for at least a second EGM of the plurality of EGMs to present an indication to other potential players that the shared bonus mode on the first EGM is open to receiving additional players for a limited amount of time, providing the generated control signal to at least the second EGM, such that the second EGM notifies other potential players that the shared bonus mode is currently available, determining that the second EGM has received a buy-in from a player before the limited amount of time has expired, and incorporating the second EGM into the shared bonus mode, such that players at both the first EGM and the second EGM are eligible to win the shared bonus mode prize.

In addition to the electronic gaming system described above, a non-transitory computer-readable medium may be provided that includes computer-executable instructions that, when executed by a hardware processor of a computing device, cause the hardware processor to: receive, via a gaming network, a communication from a first EGM of a first bank of EGMs indicating that the first EGM has entered a bonus mode according to a ball drop generated by a wide area ball call server, wherein the bonus mode is open to receiving additional players to increase a prize amount of a shared bonus mode prize, generate a control signal for at least a second EGM of the plurality of EGMs to present an indication to other potential players that the shared bonus mode on the first EGM is open to receiving additional players for a limited amount of time, provide the generated control signal to at least the second EGM, such that the second EGM notifies other potential players that the shared bonus mode is currently available, determine that the second EGM has received a buy-in from a player before the limited amount of time has expired, and incorporate the second EGM into the shared bonus mode, such that players at both the first EGM and the second EGM are eligible to win the shared bonus mode prize.

Features from any of the above-mentioned embodiments may be used in combination with one another in accordance with the general principles described herein. These and other embodiments, features, and advantages will be more fully understood upon reading the following detailed description. While the exemplary embodiments described herein are susceptible to various modifications and alternative forms, specific embodiments will be described in detail herein. However, the exemplary embodiments described herein are not intended to be limited to the particular forms disclosed. Rather, the instant disclosure covers all modifications, equivalents, and alternatives falling within this disclosure.

### BRIEF DESCRIPTION OF DRAWINGS

The accompanying appendices illustrate a number of exemplary embodiments and are a part of the specification. Together with the following description, these appendices demonstrate and explain various principles of the present disclosure.

FIG. 1 is an exemplary diagram showing several electronic gaming machines (EGMs) networked with various gaming related servers.

FIG. 2A is a block diagram showing various functional elements of an exemplary EGM.

FIG. 2B is an exemplary diagram that depicts a casino gaming environment according to one example.

FIG. 2C is a diagram that shows examples of components of a system for providing online gaming according to some aspects of the present disclosure.

FIG. 3 illustrates, in block diagram form, an implementation of a game processing architecture algorithm that implements a game processing pipeline for the play of a game in accordance with various implementations described herein.

FIG. 4 is a block diagram of an exemplary system for generating and providing shared bonus features in electronic wagering games according to one or more implementations of this disclosure.

FIG. 5 is a block diagram of an exemplary graphical interface of an electronic wagering game according to one or more implementations of this disclosure.

FIG. 6 is a flow diagram of an exemplary computer-implemented method for generating and providing shared bonus features in electronic wagering games according to one or more implementations of this disclosure.

FIG. 7 illustrates a block diagram of an embodiment in which a bankwide bonus is implemented according to one or more implementations of this disclosure.

FIGS. 8A-8D illustrate embodiments in which a bankwide bonus is provided to multiple different EGMs and players according to one or more implementations of this disclosure.

FIG. 9 is a flow diagram of an exemplary computer-implemented method for generating and providing shared bonus features in electronic wagering games according to one or more implementations of this disclosure.

FIG. 10 illustrates a block diagram showing how players are notified of and incentivized to participate in bankwide bonus features according to one or more implementations of this disclosure.

FIGS. 11A-11B illustrate embodiments in which players are notified of and incentivized to participate in bankwide bonus features according to one or more implementations of this disclosure.

FIGS. 12A-12B illustrate alternative embodiments in which players are notified of and incentivized to participate in bankwide bonus features according to one or more implementations of this disclosure.

FIG. 13 is a flow diagram of an exemplary computer-implemented method for generating and providing shared bonus features in electronic wagering games according to one or more implementations of this disclosure.

FIG. 14 illustrates a block diagram of an embodiment in which a Class II bankwide bonus is implemented according to one or more implementations of this disclosure.

FIG. 15 illustrates an embodiment in which a Class II bankwide bonus is provided to multiple different EGMs and players according to one or more implementations of this disclosure.

Throughout the appendices, identical reference characters and descriptions indicate similar, but not necessarily identical, elements. While the exemplary embodiments described herein are susceptible to various modifications and alternative forms, specific embodiments have been shown by way of example in the appendices and will be described in detail herein. However, the exemplary embodiments described herein are not intended to be limited to the particular forms disclosed. Rather, the present disclosure covers all modifications, equivalents, and alternatives falling within this disclosure.

### DETAILED DESCRIPTION

Embodiments of the instant disclosure are generally directed to generating and providing shared bonus features and shared Class III and Class II bonus games, as well as notifying potential players where and for how long these shared bonus games are available. In some examples, the electronic gaming systems may include or represent an EGM having a display, one or more input devices, a value input device, or a game controller coupled to the display, the input devices, or the value input device. The game controller may be configured to control the display to present or display an electronic wagering game. The game controller may present or display these various shared bonus games in the electronic wagering game.

For each spin within the electronic wagering game, each symbol landing may be populated with a symbol, where different symbols or combinations of symbols selected for symbol landings may yield different gameplay outcomes. The disclosed shared bonus features may include a variety of features. In one example, a single player may play a base game. As the player plays the base game, they will land specific symbols or combinations of symbols. In some cases, these values may immediately trigger a shared bonus game, while in other cases, the symbols or combinations of symbols may begin populating a bonus grid that, upon being filled, will trigger the shared bonus game. Once the shared bonus game has been triggered, the player's individual game may be opened to other players in a bankwide bonus that is provided to each of the EGMs in a bank of EGMs or may be provided to other select EGMS or select banks of EGMs within a casino. The shared bonus game may allow additional players to enter the shared game, thereby increasing the value of an associated prize or award for winning the shared bonus game. Once an end condition has been reached, the enhanced prize value is paid out to the winner of the shared bonus game.

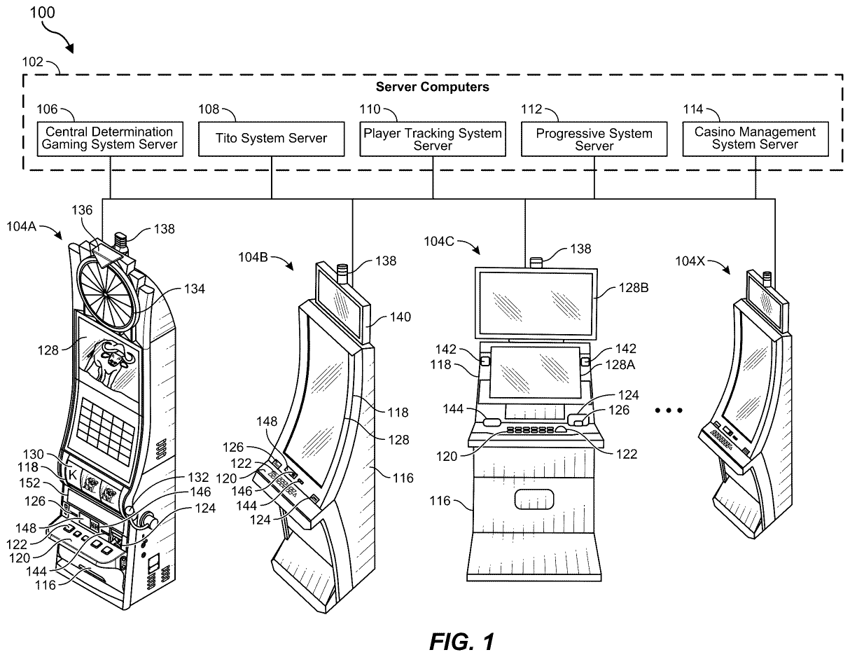

The disclosed shared bonus features and shared bonus games, which increase wins and/or the size of wins during gameplay, optimize computational efficiency by providing greater gameplay variation without the need for constant manual adjustments. For instance, in some examples, the disclosed shared bonus games may be activated using a math control table in which a bonus game is activated whenever a certain combination of selections occurs (e.g., at random), from the math control table. Moreover, in some cases where random numbers are generated and implemented within the electronic wagering game, the systems herein may carefully control or change the amount of randomness for each spin and/or for each reel in the spin to craft a specific outcome or range of outcomes. These concepts will be described below in greater detail with reference to FIGS. 1-15.

FIG. 1 illustrates several different models of EGMs which may be networked to various gaming related servers. Shown is a system 100 in a gaming environment including one or more server computers 102 (e.g., slot servers of a casino) that are in communication, via a communications network, with one or more gaming devices 104A-104X (EGMs, slots, video poker, bingo machines, etc.) that can implement one or more aspects of the present disclosure. The gaming devices 104A-104X may alternatively be portable and/or remote gaming devices such as, but not limited to, a smart phone, a tablet, a laptop, or a game console. Gaming devices 104A-104X utilize specialized software and/or hardware to form non-generic, particular machines or apparatuses that comply with regulatory requirements regarding devices used for wagering or games of chance that provide monetary awards.

Communication between the gaming devices 104A-104X and the server computers 102, and among the gaming devices 104A-104X, may be direct or indirect using one or more communication protocols. As an example, gaming devices 104A-104X and the server computers 102 can communicate over one or more communication networks, such as over the Internet through a website maintained by a computer on a remote server or over an online data network including commercial online service providers, Internet service providers, private networks (e.g., local area networks and enterprise networks), and the like (e.g., wide area networks). The communication networks could allow gaming devices 104A-104X to communicate with one another and/or the server computers 102 using a variety of communication-based technologies, such as radio frequency (RF) (e.g., wireless fidelity (WiFi®) and Bluetooth®), cable TV, satellite links and the like.

In some implementations, server computers 102 may not be necessary and/or preferred. For example, in one or more implementations, a stand-alone gaming device such as gaming device 104A, gaming device 104B or any of the other gaming devices 104C-104X can implement one or more aspects of the present disclosure. However, it is typical to find multiple EGMs connected to networks implemented with one or more of the different server computers 102 described herein.

The server computers 102 may include a central determination gaming system server 106, a ticket-in-ticket-out (TITO) system server 108, a player tracking system server 110, a progressive system server 112, and/or a casino management system server 114. Gaming devices 104A-104X may include features to enable operation of any or all servers for use by the player and/or operator (e.g., the casino, resort, gaming establishment, tavern, pub, etc.). For example, game outcomes may be generated on a central determination gaming system server 106 and then transmitted over the network to any of a group of remote terminals or remote gaming devices 104A-104X that utilize the game outcomes and display the results to the players.

Gaming device 104A is often of a cabinet construction which may be aligned in rows or banks of similar devices for placement and operation on a casino floor. The gaming device 104A often includes a main door which provides access to the interior of the cabinet. Gaming device 104A typically includes a button area or button deck 120 accessible by a player that is configured with input switches or buttons 122, an access channel for a bill validator 124, and/or an access channel for a ticket-out printer 126.

In FIG. 1, gaming device 104A is shown as a Relm XL™ model gaming device manufactured by Aristocrat® Technologies, Inc. As shown, gaming device 104A is a reel machine having a gaming display area 118 comprising a number (typically 3 or 5) of mechanical reels 130 with various symbols displayed on them. The mechanical reels 130 are independently spun and stopped to show a set of symbols within the gaming display area 118 which may be used to determine an outcome to the game.

In many configurations, the gaming device 104A may have a main display 128 (e.g., video display monitor) mounted to, or above, the gaming display area 118. The main display 128 can be a high-resolution liquid crystal display (LCD), plasma, light emitting diode (LED), or organic light emitting diode (OLED) panel which may be flat or curved as shown, a cathode ray tube, or other conventional electronically controlled video monitor.

In some implementations, the bill validator 124 may also function as a “ticket-in” reader that allows the player to use a casino issued credit ticket to load credits onto the gaming device 104A (e.g., in a cashless ticket (“TITO”) system). In such cashless implementations, the gaming device 104A may also include a “ticket-out” printer 126 for outputting a credit ticket when a “cash out” button is pressed. Cashless TITO systems are used to generate and track unique bar-codes or other indicators printed on tickets to allow players to avoid the use of bills and coins by loading credits using a ticket reader and cashing out credits using a ticket-out printer 126 on the gaming device 104A. The gaming device 104A can have hardware meters for purposes including ensuring regulatory compliance and monitoring the player credit balance. In addition, there can be additional meters that record the total amount of money wagered on the gaming device, total amount of money deposited, total amount of money withdrawn, total amount of winnings on gaming device 104A.

In some implementations, a player tracking card reader 144, a transceiver for wireless communication with a mobile device (e.g., a player's smartphone), a keypad 146, and/or an illuminated display 148 for reading, receiving, entering, and/or displaying player tracking information is provided in gaming device 104A. In such implementations, a game controller within the gaming device 104A can communicate with the player tracking system server 110 to send and receive player tracking information.

Gaming device 104A may also include a bonus topper wheel 134. When bonus play is triggered (e.g., by a player achieving a particular outcome or set of outcomes in the primary game), bonus topper wheel 134 is operative to spin and stop with indicator arrow 136 indicating the outcome of the bonus game. Bonus topper wheel 134 is typically used to play a bonus game, but it could also be incorporated into play of the base or primary game.

A candle 138 may be mounted on the top of gaming device 104A and may be activated by a player (e.g., using a switch or one of buttons 122) to indicate to operations staff that gaming device 104A has experienced a malfunction or the player requires service. The candle 138 is also often used to indicate a jackpot has been won and to alert staff that a hand payout of an award may be needed.

There may also be one or more information panels 152 which may be a back-lit, silkscreened glass panel with lettering to indicate general game information including, for example, a game denomination (e.g., $0.25 or $1), pay lines, pay tables, and/or various game related graphics. In some implementations, the information panel(s) 152 may be implemented as an additional video display.

Gaming devices 104A have traditionally also included a handle 132 typically mounted to the side of main cabinet 116 which may be used to initiate game play.

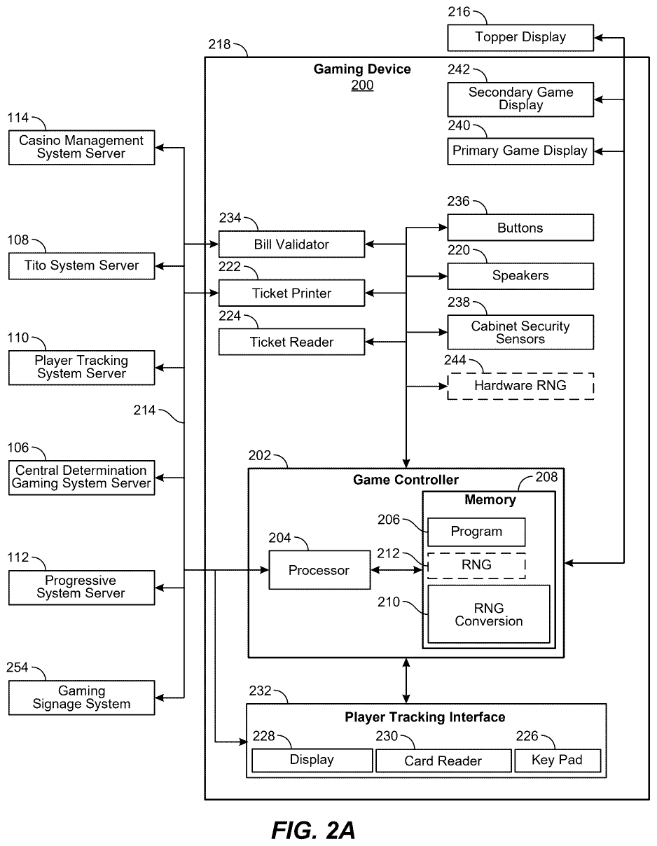

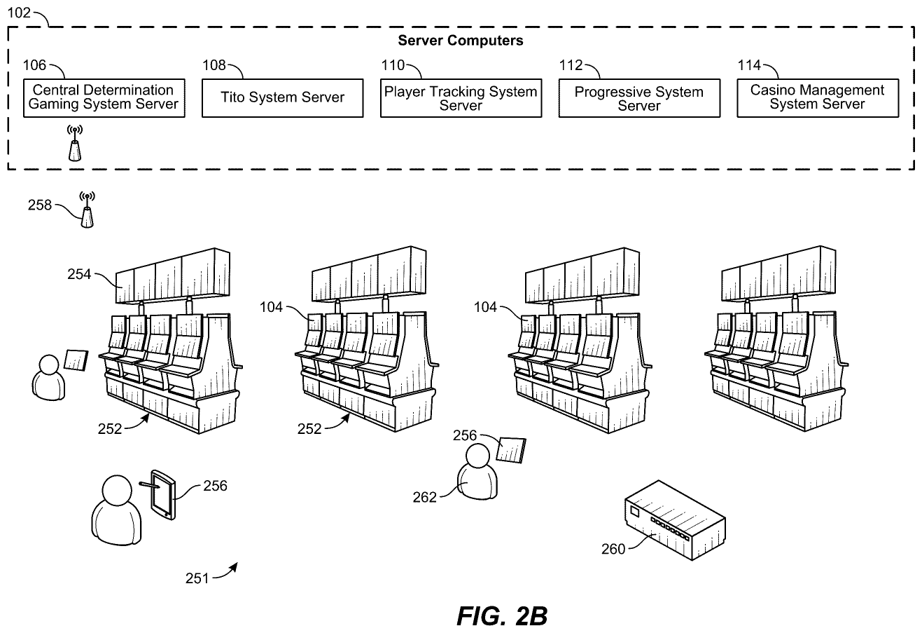

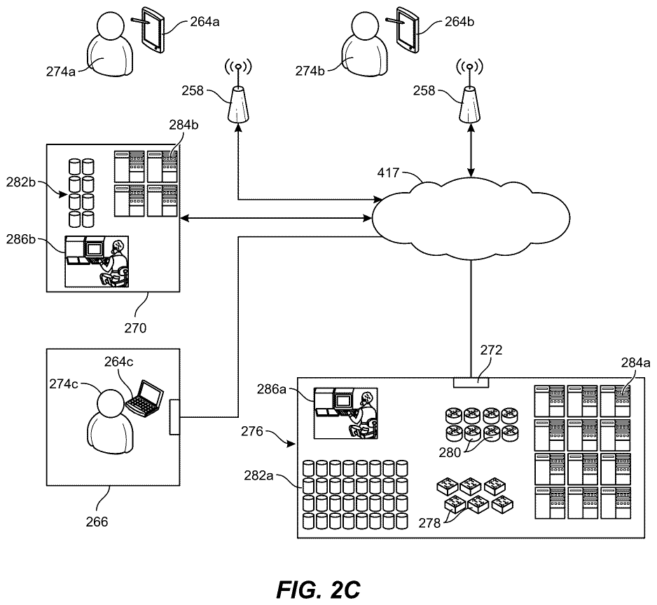

Many or all the above-described components can be controlled by circuitry (e.g., a game controller) housed inside the main cabinet 116 of the gaming device 104A, the details of which are shown in FIG. 2A.

An alternative example gaming device 104B illustrated in FIG. 1 is the Arc™ model gaming device manufactured by Aristocrat® Technologies, Inc. Note that where possible, reference numerals identifying similar features of the gaming device 104A implementation are also identified in the gaming device 104B implementation using the same reference numbers. Gaming device 104B does not include physical reels and instead shows game play functions on main display 128. An optional topper screen 140 may be used as a secondary game display for bonus play, to show game features or attraction activities while a game is not in play, or any other information or media desired by the game designer or operator. In some implementations, the optional topper screen 140 may also or alternatively be used to display progressive jackpot prizes available to a player during play of gaming device 104B.

Example gaming device 104B includes a main cabinet 116 including a main door which opens to provide access to the interior of the gaming device 104B. The main or service door is typically used by service personnel to refill the ticket-out printer 126 and collect bills and tickets inserted into the bill validator 124. The main or service door may also be accessed to reset the machine, verify and/or upgrade the software, and for general maintenance operations.

Another example gaming device 104C shown is the Helix™ model gaming device manufactured by Aristocrat® Technologies, Inc. Gaming device 104C includes a main display 128A that is in a landscape orientation. Although not illustrated by the front view provided, the main display 128A may have a curvature radius from top to bottom, or alternatively from side to side. In some implementations, main display 128A is a flat panel display. Main display 128A is typically used for primary game play while secondary display 128B is typically used for bonus game play, to show game features or attraction activities while the game is not in play or any other information or media desired by the game designer or operator. In some implementations, example gaming device 104C may also include speakers 142 to output various audio such as game sound, background music, etc.

Many different types of games, including mechanical slot games, video slot games, video poker, video black jack, video pachinko, keno, bingo, and lottery, may be provided with or implemented within the depicted gaming devices 104A-104C and other similar gaming devices. Each gaming device may also be operable to provide many different games. Games may be differentiated according to themes, sounds, graphics, type of game (e.g., slot game vs. card game vs. game with aspects of skill), denomination, number of paylines, maximum jackpot, progressive or non-progressive, bonus games, and may be deployed for operation in Class 2 or Class 3, etc.

FIG. 2A is a block diagram depicting exemplary internal electronic components of a gaming device 200 connected to various external systems. All or parts of the gaming device 200 shown could be used to implement any one of the example gaming devices 104A-X depicted in FIG. 1. As shown in FIG. 2A, gaming device 200 includes a topper display 216 or another form of a top box (e.g., a topper wheel, a topper screen, etc.) that sits above cabinet 218. Cabinet 218 or topper display 216 may also house a number of other components which may be used to add features to a game being played on gaming device 200, including speakers 220, a ticket printer 222 which prints bar-coded tickets or other media or mechanisms for storing or indicating a player's credit value, a ticket reader 224 which reads bar-coded tickets or other media or mechanisms for storing or indicating a player's credit value, and a player tracking interface 232. Player tracking interface 232 may include a keypad 226 for entering information, a player tracking display 228 for displaying information (e.g., an illuminated or video display), a card reader 230 for receiving data and/or communicating information to and from media or a device such as a smart phone enabling player tracking. FIG. 2A also depicts utilizing a ticket printer 222 to print tickets for a TITO system server 108. Gaming device 200 may further include a bill validator 234, player-input buttons 236 for player input, cabinet security sensors 238 to detect unauthorized opening of the cabinet 218, a primary game display 240, and a secondary game display 242, each coupled to and operable under the control of game controller 202.

The games available for play on the gaming device 200 are controlled by a game controller 202 that includes one or more processors 204. Processor 204 represents a general-purpose processor, a specialized processor intended to perform certain functional tasks, or a combination thereof. As an example, processor 204 can be a central processing unit (CPU) that has one or more multi-core processing units and memory mediums (e.g., cache memory) that function as buffers and/or temporary storage for data. Alternatively, processor 204 can be a specialized processor, such as an application specific integrated circuit (ASIC), graphics processing unit (GPU), field-programmable gate array (FPGA), digital signal processor (DSP), or another type of hardware accelerator. In another example, processor 204 is a system on chip (SoC) that combines and integrates one or more general-purpose processors and/or one or more specialized processors. Although FIG. 2A illustrates that game controller 202 includes a single processor 204, game controller 202 is not limited to this representation and instead can include multiple processors 204 (e.g., two or more processors).

FIG. 2A illustrates that processor 204 is operatively coupled to memory 208. Memory 208 is defined herein as including volatile and nonvolatile memory and other types of non-transitory data storage components. Volatile memory is memory that do not retain data values upon loss of power. Nonvolatile memory is memory that do retain data upon a loss of power. Examples of memory 208 include random access memory (RAM), read-only memory (ROM), hard disk drives, solid-state drives, universal serial bus (USB) flash drives, memory cards accessed via a memory card reader, floppy disks accessed via an associated floppy disk drive, optical discs accessed via an optical disc drive, magnetic tapes accessed via an appropriate tape drive, and/or other memory components, or a combination of any two or more of these memory components. In addition, examples of RAM include static random-access memory (SRAM), dynamic random access memory (DRAM), magnetic random access memory (MRAM), and other such devices. Examples of ROM include a programmable read-only memory (PROM), an erasable programmable read-only memory (EPROM), an electrically erasable programmable read-only memory (EEPROM), or other like memory device. Even though FIG. 2A illustrates that game controller 202 includes a single memory 208, game controller 202 could include multiple memories 208 for storing program instructions and/or data.

Memory 208 can store one or more game programs 206 that provide program instructions and/or data for carrying out various implementations (e.g., game mechanics) described herein. Stated another way, game program 206 represents an executable program stored in any portion or component of memory 208. In one or more implementations, game program 206 is embodied in the form of source code that includes human-readable statements written in a programming language or machine code that contains numerical instructions recognizable by a suitable execution system, such as a processor 204 in a game controller or other system. Examples of executable programs include: (1) a compiled program that can be translated into machine code in a format that can be loaded into a random access portion of memory 208 and run by processor 204; (2) source code that may be expressed in proper format such as object code that is capable of being loaded into a random access portion of memory 208 and executed by processor 204; and (3) source code that may be interpreted by another executable program to generate instructions in a random access portion of memory 208 to be executed by processor 204.

Alternatively, game programs 206 can be set up to generate one or more game instances based on instructions and/or data that gaming device 200 exchanges with one or more remote gaming devices, such as a central determination gaming system server 106 (not shown in FIG. 2A but shown in FIG. 1). For purpose of this disclosure, the term “game instance” refers to a play or a round of a game that gaming device 200 presents (e.g., via a user interface (UI)) to a player. The game instance is communicated to gaming device 200 via the network 214 and then displayed on gaming device 200. For example, gaming device 200 may execute game program 206 as video streaming software that allows the game to be displayed on gaming device 200. When a game is stored on gaming device 200, it may be loaded from memory 208 (e.g., from a read only memory (ROM)) or from the central determination gaming system server 106 to memory 208.

Gaming devices, such as gaming device 200, are highly regulated to ensure fairness and, in many cases, gaming device 200 is operable to award monetary awards (e.g., typically dispensed in the form of a redeemable voucher). Therefore, to satisfy security and regulatory requirements in a gaming environment, hardware and software architectures are implemented in gaming devices 200 that differ significantly from those of general-purpose computers. Adapting general purpose computers to function as gaming devices 200 is not simple or straightforward because of: (1) the regulatory requirements for gaming devices 200, (2) the harsh environment in which gaming devices 200 operate, (3) security requirements, (4) fault tolerance requirements, and (5) the requirement for additional special purpose componentry enabling functionality of an EGM. These differences require substantial engineering effort with respect to game design implementation, game mechanics, hardware components, and software.

One regulatory requirement for games running on gaming device 200 generally involves complying with a certain level of randomness. Typically, gaming jurisdictions mandate that gaming devices 200 satisfy a minimum level of randomness without specifying how a gaming device 200 should achieve this level of randomness. To comply, FIG. 2A illustrates that gaming device 200 could include an RNG 212 that utilizes hardware and/or software to generate RNG outcomes that lack any pattern. The RNG operations are often specialized and non-generic in order to comply with regulatory and gaming requirements. For example, in a slot game, game program 206 can initiate multiple RNG calls to RNG 212 to generate RNG outcomes, where each RNG call and RNG outcome corresponds to an outcome for a reel. In another example, gaming device 200 can be a Class II gaming device where RNG 212 generates RNG outcomes for creating Bingo cards. In one or more implementations, RNG 212 could be one of a set of RNGs operating on gaming device 200. More generally, an output of the RNG 212 can be the basis on which game outcomes are determined by the game controller 202. Game developers could vary the degree of true randomness for each RNG (e.g., pseudorandom) and utilize specific RNGs depending on game requirements. The output of the RNG 212 can include a random number or pseudorandom number (either is generally referred to as a “random number”).

In FIG. 2A, RNG 212 and hardware RNG 244 are shown in dashed lines to illustrate that RNG 212, hardware RNG 244, or both can be included in gaming device 200. In one implementation, instead of including RNG 212, gaming device 200 could include a hardware RNG 244 that generates RNG outcomes. Analogous to RNG 212, hardware RNG 244 performs specialized and non-generic operations in order to comply with regulatory and gaming requirements. For example, because of regulation requirements, hardware RNG 244 could be a random number generator that securely produces random numbers for cryptography use. The gaming device 200 then uses the secure random numbers to generate game outcomes for one or more game features. In another implementation, the gaming device 200 could include both hardware RNG 244 and RNG 212. RNG 212 may utilize the RNG outcomes from hardware RNG 244 as one of many sources of entropy for generating secure random numbers for the game features.

Another regulatory requirement for running games on gaming device 200 includes ensuring a certain level of RTP. Similar to the randomness requirement discussed above, numerous gaming jurisdictions also mandate that gaming device 200 provides a minimum level of RTP (e.g., RTP of at least 75%). A game can use one or more lookup tables (also called weighted tables) as part of a technical solution that satisfies regulatory requirements for randomness and RTP. In particular, a lookup table can integrate game features (e.g., trigger events for special modes or bonus games; newly introduced game elements such as extra reels, new symbols, or new cards; stop positions for dynamic game elements such as spinning reels, spinning wheels, or shifting reels; or card selections from a deck) with random numbers generated by one or more RNGs, so as to achieve a given level of volatility for a target level of RTP. (In general, volatility refers to the frequency or probability of an event such as a special mode, payout, etc. For example, for a target level of RTP, a higher-volatility game may have a lower payout most of the time with an occasional bonus having a very high payout, while a lower-volatility game has a steadier payout with more frequent bonuses of smaller amounts.) Configuring a lookup table can involve engineering decisions with respect to how RNG outcomes are mapped to game outcomes for a given game feature, while still satisfying regulatory requirements for RTP. Configuring a lookup table can also involve engineering decisions about whether different game features are combined in a given entry of the lookup table or split between different entries (for the respective game features), while still satisfying regulatory requirements for RTP and allowing for varying levels of game volatility.

FIG. 2A illustrates that gaming device 200 includes an RNG conversion engine 210 that translates the RNG outcome from RNG 212 to a game outcome presented to a player. To meet a designated RTP, a game developer can set up the RNG conversion engine 210 to utilize one or more lookup tables to translate the RNG outcome to a symbol element, stop position on a reel strip layout, and/or randomly chosen aspect of a game feature. As an example, the lookup tables can regulate a prize payout amount for each RNG outcome and how often the gaming device 200 pays out the prize payout amounts. The RNG conversion engine 210 could utilize one lookup table to map the RNG outcome to a game outcome displayed to a player and a second lookup table as a pay table for determining the prize payout amount for each game outcome. The mapping between the RNG outcome to the game outcome controls the frequency in hitting certain prize payout amounts.

FIG. 2A also depicts that gaming device 200 is connected over network 214 to player tracking system server 110. Player tracking system server 110 may be, for example, an OASIS® system manufactured by Aristocrat® Technologies, Inc. Player tracking system server 110 is used to track play (e.g. amount wagered, games played, time of play and/or other quantitative or qualitative measures) for individual players so that an operator may reward players in a loyalty program. The player may use the player tracking interface 232 to access his/her account information, activate free play, and/or request various information. Player tracking or loyalty programs seek to reward players for their play and help build brand loyalty to the gaming establishment. The rewards typically correspond to the player's level of patronage (e.g., to the player's playing frequency and/or total amount of game plays at a given casino). Player tracking rewards may be complimentary and/or discounted meals, lodging, entertainment and/or additional play. Player tracking information may be combined with other information that is now readily obtainable by a casino management system.

When a player wishes to play the gaming device 200, he/she can insert cash or a ticket voucher through a coin acceptor (not shown) or bill validator 234 to establish a credit balance on the gaming device. The credit balance is used by the player to place wagers on instances of the game and to receive credit awards based on the outcome of winning instances. The credit balance is decreased by the amount of each wager and increased upon a win. The player can add additional credits to the balance at any time. The player may also optionally insert a loyalty club card into the card reader 230. During the game, the player views with one or more UIs, the game outcome on one or more of the primary game display 240 and secondary game display 242. Other game and prize information may also be displayed.

For each game instance, a player may make selections, which may affect play of the game. For example, the player may vary the total amount wagered by selecting the amount bet per line and the number of lines played. In many games, the player is asked to initiate or select options during course of game play (such as spinning a wheel to begin a bonus round or select various items during a feature game). The player may make these selections using the player-input buttons 236, the primary game display 240 which may be a touch screen or using some other device which enables a player to input information into the gaming device 200.

During certain game events, the gaming device 200 may display visual and auditory effects that can be perceived by the player. These effects add to the excitement of a game, which makes a player more likely to enjoy the playing experience. Auditory effects include various sounds that are projected by the speakers 220. Visual effects include flashing lights, strobing lights or other patterns displayed from lights on the gaming device 200 or from lights behind the information panel 152 (FIG. 1).

When the player is done, he/she cashes out the credit balance (typically by pressing a cash out button to receive a ticket from the ticket printer 222). The ticket may be “cashed-in” for money or inserted into another machine to establish a credit balance for play.

Additionally, or alternatively, gaming devices 104A-104X and 200 can include or be coupled to one or more wireless transmitters, receivers, and/or transceivers (not shown in FIGS. 1 and 2A) that communicate (e.g., Bluetooth® or other near-field communication technology) with one or more mobile devices to perform a variety of wireless operations in a casino environment. Examples of wireless operations in a casino environment include detecting the presence of mobile devices, performing credit, points, comps, or other marketing or hard currency transfers, establishing wagering sessions, and/or providing a personalized casino-based experience using a mobile application. In one implementation, to perform these wireless operations, a wireless transmitter or transceiver initiates a secure wireless connection between a gaming device 104A-104X and 200 and a mobile device. After establishing a secure wireless connection between the gaming device 104A-104X and 200 and the mobile device, the wireless transmitter or transceiver does not send and/or receive application data to and/or from the mobile device. Rather, the mobile device communicates with gaming devices 104A-104X and 200 using another wireless connection (e.g., WiFi® or cellular network). In another implementation, a wireless transceiver establishes a secure connection to directly communicate with the mobile device. The mobile device and gaming device 104A-104X and 200 sends and receives data utilizing the wireless transceiver instead of utilizing an external network. For example, the mobile device would perform digital wallet transactions by directly communicating with the wireless transceiver. In one or more implementations, a wireless transmitter could broadcast data received by one or more mobile devices without establishing a pairing connection with the mobile devices.

Although FIGS. 1 and 2A illustrate specific implementations of a gaming device (e.g., gaming devices 104A-104X and 200), the disclosure is not limited to those implementations shown in FIGS. 1 and 2. For example, not all gaming devices suitable for implementing implementations of the present disclosure necessarily include top wheels, top boxes, information panels, cashless ticket systems, and/or player tracking systems. Further, some suitable gaming devices have only a single game display that includes only a mechanical set of reels and/or a video display, while others are designed for bar counters or tabletops and have displays that face upwards. Gaming devices 104A-104X and 200 may also include other processors that are not separately shown. Using FIG. 2A as an example, gaming device 200 could include display controllers (not shown in FIG. 2A) configured to receive video input signals or instructions to display images on game displays 240 and 242. Alternatively, such display controllers may be integrated into the game controller 202. The use and discussion of FIGS. 1 and 2 are examples to facilitate ease of description and explanation.

FIG. 2B depicts a casino gaming environment according to one example. In this example, the casino 251 includes banks 252 of EGMs 104. In this example, each bank 252 of EGMs 104 includes a corresponding gaming signage system 254 (also shown in FIG. 2A). According to this implementation, the casino 251 also includes mobile gaming devices 256, which are also configured to present wagering games in this example. The mobile gaming devices 256 may, for example, include tablet devices, cellular phones, smart phones and/or other handheld devices. In this example, the mobile gaming devices 256 are configured for communication with one or more other devices in the casino 251, including but not limited to one or more of the server computers 102, via wireless access points 258.

According to some examples, the mobile gaming devices 256 may be configured for stand-alone determination of game outcomes. However, in some alternative implementations the mobile gaming devices 256 may be configured to receive game outcomes from another device, such as the central determination gaming system server 106, one of the EGMs 104, etc.

Some mobile gaming devices 256 may be configured to accept monetary credits from a credit or debit card, via a wireless interface (e.g., via a wireless payment app), via tickets, via a patron casino account, etc. However, some mobile gaming devices 256 may not be configured to accept monetary credits via a credit or debit card. Some mobile gaming devices 256 may include a ticket reader and/or a ticket printer whereas some mobile gaming devices 256 may not, depending on the particular implementation.

In some implementations, the casino 251 may include one or more kiosks 260 that are configured to facilitate monetary transactions involving the mobile gaming devices 256, which may include cash out and/or cash in transactions. The kiosks 260 may be configured for wired and/or wireless communication with the mobile gaming devices 256. The kiosks 260 may be configured to accept monetary credits from casino patrons 262 and/or to dispense monetary credits to casino patrons 262 via cash, a credit or debit card, via a wireless interface (e.g., via a wireless payment app), via tickets, etc. According to some examples, the kiosks 260 may be configured to accept monetary credits from a casino patron and to provide a corresponding amount of monetary credits to a mobile gaming device 256 for wagering purposes, e.g., via a wireless link such as a near-field communications link. In some such examples, when a casino patron 262 is ready to cash out, the casino patron 262 may select a cash out option provided by a mobile gaming device 256, which may include a real button or a virtual button (e.g., a button provided via a graphical user interface) in some instances. In some such examples, the mobile gaming device 256 may send a “cash out” signal to a kiosk 260 via a wireless link in response to receiving a “cash out” indication from a casino patron. The kiosk 260 may provide monetary credits to the casino patron 262 corresponding to the “cash out” signal, which may be in the form of cash, a credit ticket, a credit transmitted to a financial account corresponding to the casino patron, etc.

In some implementations, a cash-in process and/or a cash-out process may be facilitated by the TITO system server 108. For example, the TITO system server 108 may control, or at least authorize, ticket-in and ticket-out transactions that involve a mobile gaming device 256 and/or a kiosk 260.

Some mobile gaming devices 256 may be configured for receiving and/or transmitting player loyalty information. For example, some mobile gaming devices 256 may be configured for wireless communication with the player tracking system server 110. Some mobile gaming devices 256 may be configured for receiving and/or transmitting player loyalty information via wireless communication with a patron's player loyalty card, a patron's smartphone, etc.

According to some implementations, a mobile gaming device 256 may be configured to provide safeguards that prevent the mobile gaming device 256 from being used by an unauthorized person. For example, some mobile gaming devices 256 may include one or more biometric sensors and may be configured to receive input via the biometric sensor(s) to verify the identity of an authorized patron. Some mobile gaming devices 256 may be configured to function only within a predetermined or configurable area, such as a casino gaming area.

FIG. 2C is a diagram that shows examples of components of a system for providing online gaming according to some aspects of the present disclosure. As with other figures presented in this disclosure, the numbers, types and arrangements of gaming devices shown in FIG. 2C are merely shown by way of example. In this example, various gaming devices, including but not limited to end user devices (EUDs) 264a, 264b and 264c are capable of communication via one or more networks 417. The networks 417 may, for example, include one or more cellular telephone networks, the Internet, etc. In this example, the EUDs 264a and 264b are mobile devices: according to this example the EUD 264a is a tablet device and the EUD 264b is a smart phone. In this implementation, the EUD 264c is a laptop computer that is located within a residence 266 at the time depicted in FIG. 2C. Accordingly, in this example the hardware of EUDs is not specifically configured for online gaming, although each EUD is configured with software for online gaming. For example, each EUD may be configured with a web browser. Other implementations may include other types of EUD, some of which may be specifically configured for online gaming.

In this example, a gaming data center 276 includes various devices that are configured to provide online wagering games via the networks 417. The gaming data center 276 is capable of communication with the networks 417 via the gateway 272. In this example, switches 278 and routers 280 are configured to provide network connectivity for devices of the gaming data center 276, including storage devices 282a, servers 284a and one or more workstations 270a. The servers 284a may, for example, be configured to provide access to a library of games for online game play. In some examples, code for executing at least some of the games may initially be stored on one or more of the storage devices 282a. The code may be subsequently loaded onto a server 284a after selection by a player via an EUD and communication of that selection from the EUD via the networks 417. The server 284a onto which code for the selected game has been loaded may provide the game according to selections made by a player and indicated via the player's EUD. In other examples, code for executing at least some of the games may initially be stored on one or more of the servers 284a. Although only one gaming data center 276 is shown in FIG. 2C, some implementations may include multiple gaming data centers 276.

In this example, a financial institution data center 270 is also configured for communication via the networks 417. Here, the financial institution data center 270 includes servers 284b, storage devices 282b, and one or more workstations 286a. According to this example, the financial institution data center 270 is configured to maintain financial accounts, such as checking accounts, savings accounts, loan accounts, etc. In some implementations one or more of the authorized users 274a-274c may maintain at least one financial account with the financial institution that is serviced via the financial institution data center 270.

According to some implementations, the gaming data center 276 may be configured to provide online wagering games in which money may be won or lost. According to some such implementations, one or more of the servers 284a may be configured to monitor player credit balances, which may be expressed in game credits, in currency units, or in any other appropriate manner. In some implementations, the server(s) 284a may be configured to obtain financial credits from and/or provide financial credits to one or more financial institutions, according to a player's “cash in” selections, wagering game results and a player's “cash out” instructions. According to some such implementations, the server(s) 284a may be configured to electronically credit or debit the account of a player that is maintained by a financial institution, e.g., an account that is maintained via the financial institution data center 270. The server(s) 284a may, in some examples, be configured to maintain an audit record of such transactions.

In some alternative implementations, the gaming data center 276 may be configured to provide online wagering games for which credits may not be exchanged for cash or the equivalent. In some such examples, players may purchase game credits for online game play, but may not “cash out” for monetary credit after a gaming session. Moreover, although the financial institution data center 270 and the gaming data center 276 include their own servers and storage devices in this example, in some examples the financial institution data center 270 and/or the gaming data center 276 may use offsite “cloud-based” servers and/or storage devices. In some alternative examples, the financial institution data center 270 and/or the gaming data center 276 may rely entirely on cloud-based servers.

One or more types of devices in the gaming data center 276 (or elsewhere) may be capable of executing middleware, e.g., for data management and/or device communication. Authentication information, player tracking information, etc., including but not limited to information obtained by EUDs 264 and/or other information regarding authorized users of EUDs 264 (including but not limited to the authorized users 274a-274c), may be stored on storage devices 282 and/or servers 284. Other game-related information and/or software, such as information and/or software relating to leaderboards, players currently playing a game, game themes, game-related promotions, game competitions, etc., also may be stored on storage devices 282 and/or servers 284. In some implementations, some such game-related software may be available as “apps” and may be downloadable (e.g., from the gaming data center 276) by authorized users.

In some examples, authorized users and/or entities (such as representatives of gaming regulatory authorities) may obtain gaming-related information via the gaming data center 276. One or more other devices (such EUDs 264 or devices of the gaming data center 276) may act as intermediaries for such data feeds. Such devices may, for example, be capable of applying data filtering algorithms, executing data summary and/or analysis software, etc. In some implementations, data filtering, summary and/or analysis software may be available as “apps” and downloadable by authorized users.

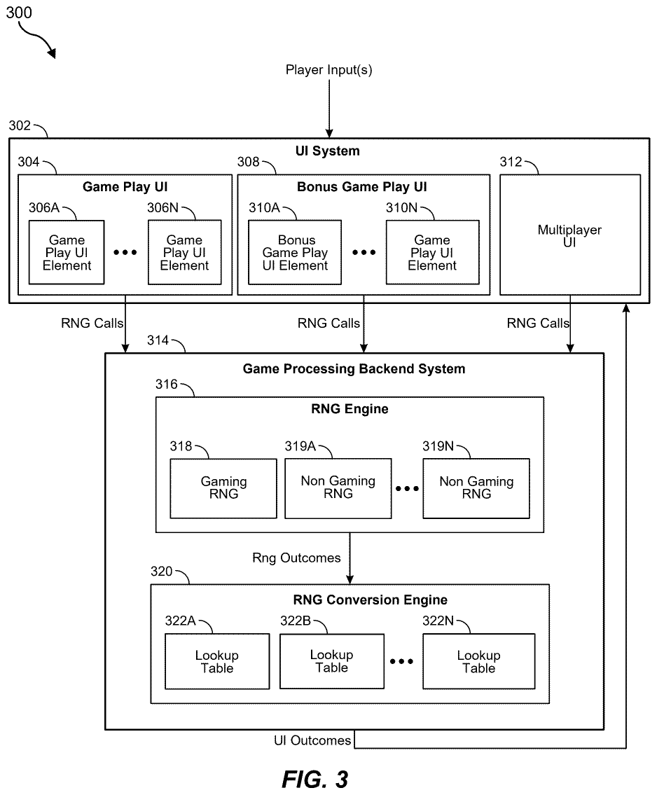

FIG. 3 illustrates, in block diagram form, an implementation of a game processing architecture 300 that implements a game processing pipeline for the play of a game in accordance with various implementations described herein. As shown in FIG. 3, the gaming processing pipeline starts with having a UI system 302 receive one or more player inputs for the game instance. Based on the player input(s), the UI system 302 generates and sends one or more RNG calls to a game processing backend system 314. Game processing backend system 314 then processes the RNG calls with RNG engine 316 to generate one or more RNG outcomes. The RNG outcomes are then sent to the RNG conversion engine 320 to generate one or more game outcomes for the UI system 302 to display to a player. The game processing architecture 300 can implement the game processing pipeline using a gaming device, such as gaming devices 104A-104X and 200 shown in FIGS. 1 and 2, respectively. Alternatively, portions of the gaming processing architecture 300 can implement the game processing pipeline using a gaming device and one or more remote gaming devices, such as central determination gaming system server 106 shown in FIG. 1.

The UI system 302 includes one or more UIs that a player can interact with. The UI system 302 could include one or more game play UIs 304, one or more bonus game play UIs 308, and one or more multiplayer UIs 312, where each UI type includes one or more mechanical UIs and/or graphical UIs (GUIs). In other words, game play UI 304, bonus game play UI 308, and the multiplayer UI 312 may utilize a variety of UI elements, such as mechanical UI elements (e.g., physical “spin” button or mechanical reels) and/or GUI elements (e.g., virtual reels shown on a video display or a virtual button deck) to receive player inputs and/or present game play to a player. Using FIG. 3 as an example, the different UI elements are shown as game play UI elements 306A-306N and bonus game play UI elements 310A-310N.

The game play UI 304 represents a UI that a player typically interfaces with for a base game. During a game instance of a base game, the game play UI elements 306A-306N (e.g., GUI elements depicting one or more virtual reels) are shown and/or made available to a user. In a subsequent game instance, the UI system 302 could transition out of the base game to one or more bonus games. The bonus game play UI 308 represents a UI that utilizes bonus game play UI elements 310A-310N for a player to interact with and/or view during a bonus game. In one or more implementations, at least some of the game play UI element 306A-306N are similar to the bonus game play UI elements 310A-310N. In other implementations, the game play UI element 306A-306N can differ from the bonus game play UI elements 310A-310N.

FIG. 3 also illustrates that UI system 302 could include a multiplayer UI 312 purposed for game play that differs or is separate from the typical base game. For example, multiplayer UI 312 could be set up to receive player inputs and/or presents game play information relating to a tournament mode. When a gaming device transitions from a primary game mode that presents the base game to a tournament mode, a single gaming device is linked and synchronized to other gaming devices to generate a tournament outcome. For example, multiple RNG engines 316 corresponding to each gaming device could be collectively linked to determine a tournament outcome. To enhance a player's gaming experience, tournament mode can modify and synchronize sound, music, reel spin speed, and/or other operations of the gaming devices according to the tournament game play. After tournament game play ends, operators can switch back the gaming device from tournament mode to a primary game mode to present the base game. Although FIG. 3 does not explicitly depict that multiplayer UI 312 includes UI elements, multiplayer UI 312 could also include one or more multiplayer UI elements.

Based on the player inputs, the UI system 302 could generate RNG calls to a game processing backend system 314. As an example, the UI system 302 could use one or more application programming interfaces (APIs) to generate the RNG calls. To process the RNG calls, the RNG engine 316 could utilize gaming RNG 318 and/or non-gaming RNGs 319A-319N. Gaming RNG 318 could corresponds to RNG 212 or hardware RNG 244 shown in FIG. 2A. As previously discussed with reference to FIG. 2A, gaming RNG 318 often performs specialized and non-generic operations that comply with regulatory and/or game requirements. For example, because of regulation requirements, gaming RNG 318 could correspond to RNG 212 by being a cryptographic RNG or pseudorandom number generator (PRNG) (e.g., Fortuna PRNG) that securely produces random numbers for one or more game features. To securely generate random numbers, gaming RNG 318 could collect random data from various sources of entropy, such as from an operating system (OS) and/or a hardware RNG (e.g., hardware RNG 244 shown in FIG. 2A). Alternatively, non-gaming RNGs 319A-319N may not be cryptographically secure and/or be computationally less expensive. Non-gaming RNGs 319A-319N can, thus, be used to generate outcomes for non-gaming purposes. As an example, non-gaming RNGs 319A-319N can generate random numbers for generating random messages that appear on the gaming device.

The RNG conversion engine 320 processes each RNG outcome from RNG engine 316 and converts the RNG outcome to a UI outcome that is feedback to the UI system 302. With reference to FIG. 2A, RNG conversion engine 320 corresponds to RNG conversion engine 210 used for game play. As previously described, RNG conversion engine 320 translates the RNG outcome from the RNG 212 to a game outcome presented to a player. RNG conversion engine 320 utilizes one or more lookup tables 322A-322N to regulate a prize payout amount for each RNG outcome and how often the gaming device pays out the derived prize payout amounts. In one example, the RNG conversion engine 320 could utilize one lookup table to map the RNG outcome to a game outcome displayed to a player and a second lookup table as a pay table for determining the prize payout amount for each game outcome. In this example, the mapping between the RNG outcome and the game outcome controls the frequency in hitting certain prize payout amounts. Different lookup tables could be utilized depending on the different game modes, for example, a base game versus a bonus game.

After generating the UI outcome, the game processing backend system 314 sends the UI outcome to the UI system 302. Examples of UI outcomes are symbols to display on a video reel or reel stops for a mechanical reel. In one example, if the UI outcome is for a base game, the UI system 302 updates one or more game play UI elements 306A-306N, such as symbols, for the game play UI 304. In another example, if the UI outcome is for a bonus game, the UI system could update one or more bonus game play UI elements 310A-310N (e.g., symbols) for the bonus game play UI 308. In response to updating the appropriate UI, the player may subsequently provide additional player inputs to initiate a subsequent game instance that progresses through the game processing pipeline.

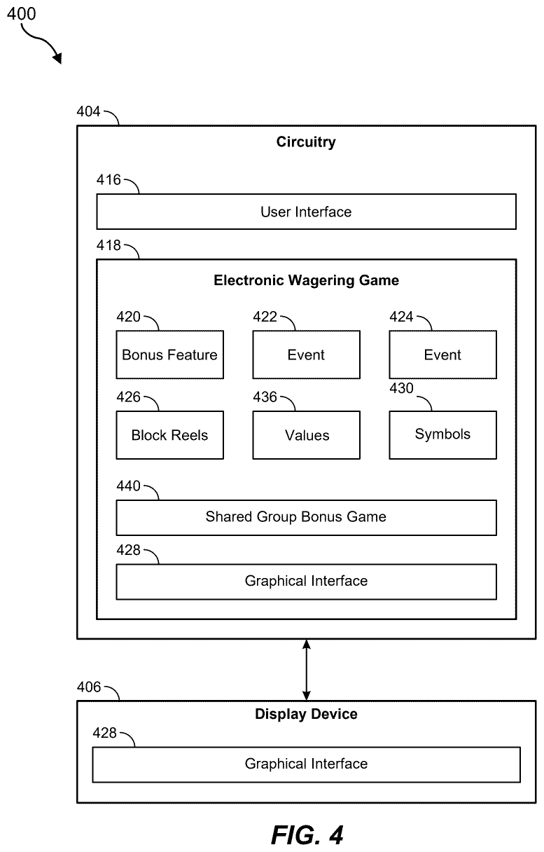

Turning now to FIGS. 4-15, embodiments are described for generating and providing shared bonus features in Class II and Class III games, as well as notifying potential players where and for how long these shared bonus games are available. These embodiments will be described in conjunction with the systems and methods described above in FIGS. 1-3. FIG. 4 illustrates an exemplary system 400 for providing and displaying visually interactive bonus features, including a shared bonus game, within an electronic wagering game. As illustrated in FIG. 4, system 400 may include or represent circuitry 404 and a display device 406. In some examples, circuitry 404 may implement or execute an electronic wagering game 418 in conjunction with display device 406. In one example, circuitry 404 may include or represent a user interface 416 that enables a user to enter or provide input in connection with electronic wagering game 418. In this example, circuitry 404 may direct or cause display device 406 to render or present a graphical interface 428 of electronic wagering game 418 for viewing by the user.

In some examples, electronic wagering game 418 may include or represent block reels 426 configured to spin in connection with wagers made by the user. In one example, block reels 426 may include, represent, or render symbols 430 that spin, rotate, or change during gameplay. In this example, certain combinations or sequences of symbols 430 across block reels 426 may constitute a win or increase for the user. As a result, the electronic wagering game 418 may award or grant, to the user, a certain monetary value or credit associated with one or more of symbols 430 or their corresponding combinations or sequences.

In some examples, circuitry 404 may detect, recognize, or identify an event 422 that triggers or activates a bonus feature 420, such as a free spins feature. For example, event 422 may include or involve determining that block reels 426 have rendered a threshold number of select symbols (e.g., scatter symbols) during a pre-bonus reel spin. In another example, event 422 may include or represent a random occurrence, a performance-driven occurrence, a wager-driven occurrence, or a time-driven occurrence. For example, event 422 may occur as a result of random number generation. Additionally or alternatively, event 422 may occur as a result of a certain amount of time having elapsed since a previous bonus was awarded by electronic wagering game 418. In other cases, event 422 may occur upon reaching a specified number of specified symbols or values (e.g., cash on reels (COR) values) in a base game or in a shared bonus grid. This, in turn, may trigger a shared group bonus game 440 that can be joined by additional users.

In some examples, circuitry 404 may implement or execute a group bonus game 440 within electronic wagering game 418 in response to event 422. In one example, the group bonus game 440 may include a grid of positions (e.g., a 5×5 grid of positions), with some positions having numerical values and other positions having boosts or enhancements. The group bonus game 440 may include a variety of different types of game play, including options to spin reels of grid positions in an attempt to increase the value of the group bonus game prize. At least in some cases, as more users join the group bonus game 440, the group bonus prize will increase in value until a maximum number of players is reached. At that point, an end condition 424 will be met and the shared group bonus game will end. The winner of the shared group bonus game 440 will then receive the prize at the enhanced value that has been boosted by the play of the additional users. The circuitry 404 will then return the electronic wagering game to its original form within the base game (e.g., a 3×5 array in a graphical interface).

In some examples, circuitry 404 may include or represent one or more electrical or electronic circuits capable of processing, applying, modifying, transforming, displaying, transmitting, receiving, or executing data for system 400. Circuitry 404 may be communicatively or electrically coupled to display device 406. In one example, circuitry 404 may access or analyze data stored in memory to facilitate or support providing or displaying visually interactive bonus features in electronic wagering games. Additionally or alternatively, circuitry 404 may launch, perform, or execute certain executable files, code snippets, or computer-readable instructions to facilitate or support activating or displaying conditional bonus feature 420. In certain implementations, circuitry 404 may provide display device 406 with instructions or commands that, upon execution, cause display device 406 to present and/or modify graphical interface 428 in accordance with the progression of electronic wagering game 418.

Although illustrated as a single unit in FIG. 4, circuitry 404 may include or represent a collection of multiple processing units or electrical or electronic components that work or operate in conjunction with one another. In one example, circuitry 404 may include or represent a central processing unit (CPU) and/or a graphics processing unit (GPU). In another example, circuitry 404 may include or represent an application-specific integrated circuit (ASIC). In certain implementations, circuitry 404 may be included in or incorporated in an EGM.

Additionally or alternatively, circuitry 404 may be included or incorporated in a server or one or more client devices of system 400. Examples of circuitry 404 include, without limitation, processing devices, microprocessors, microcontrollers, GPUs, CPUs, ASICs, field-programmable gate arrays (FPGAs), systems on chips (SoCs), parallel accelerated processors, tensor cores, integrated circuits, chiplets, optical modules, receivers, transmitters, transceivers, storage devices, memory devices, logical circuitry, portions of one or more of the same, variations or combinations of one or more of the same, or any other suitable circuitry.

In some examples, graphical interface 428 of electronic wagering game 418 may include or represent one or more graphical representations or visuals. In one example, graphical interface 428 may include or represent graphical objects that represent certain features or attributes of the gameplay, such as values 436 or credits accumulated by various users, increments on progressives, durations or amounts of time since the last time a certain bonus was awarded, etc. Additionally or alternatively, graphical interface 428 may include or represent perceived-persistence graphics, pseudo-persistence graphics, and/or true-persistence graphics.

In some examples, the various devices, components, or features described in connection with FIG. 4 may include or represent one or more additional circuits, components, or features that are not necessarily illustrated or labeled in FIG. 4. For example, the systems, components, or features illustrated in FIG. 4 may also include or represent additional analog or digital circuitry, onboard logic, transistors, radio-frequency (RF) transmitters, RF receivers, transceivers, antennas, resistors, capacitors, diodes, inductors, switches, registers, flipflops, digital logic, connections, traces, buses, semiconductor (e.g., silicon) devices or structures, processing devices, storage devices, memory devices, circuit boards, sensors, packages, substrates, housings, servers, client devices, computing devices, combinations or variations of one or more of the same, or any other suitable components. In certain implementations, one or more of these additional circuits, components, or features may be inserted or applied between any of the existing circuits, components, or features illustrated in FIG. 4 consistent with the aims or objectives described herein. Accordingly, the couplings or connections described with reference to FIG. 4 may be direct connections with no intermediate components, devices, or nodes or indirect connections with one or more intermediate components, devices, or nodes.

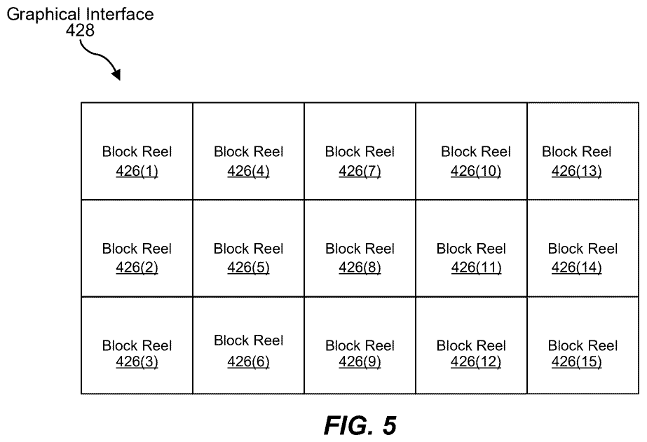

FIG. 5 illustrates an exemplary implementation of graphical interface 428 presented via display device 406. In some examples, graphical interface 428 may include or represent certain elements, components, and/or features that perform or provide functionalities that are similar or identical to those described above in connection with any of FIGS. 1-4. As illustrated in FIG. 5, graphical interface 428 may include or represent a reel window or matrix consisting of block reels 426(1), 426(2), 426(3), 426(4), 426(5), 426(6), 426(7), 426(8), 426(9), 426(10), 426(11), 426(12), 426(13), 426(14), and 426(15). For example, graphical interface 428 may constitute or represent a 3×5 reel window or array prior to the implementation of a conditional bonus feature 420. In certain implementations, each of block reels 426(1)-(15) may constitute or represent an independent reel of the electronic wagering game 418.

In some embodiments, an electronic gaming system may be provided. The electronic gaming system may include a housing. The housing may be similar to or the same as cabinet 218 described above in conjunction with FIG. 2. The housing may provide structural support for an electronic display device that is mounted to the housing. The housing may also provide structural support for at least one input device using which a game player can provide inputs to the electronic gaming system. The input device may be a physical button or set of buttons that are pressed, alone or in conjunction, to provide game inputs. The input device may additionally or alternatively include a touchscreen display that provides input graphical display elements.

The electronic gaming system may also include a value input device and/or a value output device. The value input device may include a physical bill acceptor, a coin acceptor, or an electronic card reader configured to wirelessly or physically interface with a credit card, debit card, or stored value card that adds money or credits with which to wager. The value input device may be linked to monetary systems or databases that provide value to the electronic gaming system that can be used within the electronic wagering game. The value output device may similarly include a bill acceptor or bill output device or coin acceptor or output device that dispenses physical currency.

The value output device may also include an electronic card reader that wirelessly or physically interfaces with a credit card, debit card, stored value card, or digital wallet to apply money to that card or associated account or dispense payout of physical currency. Both the value input device and the value output device may be controlled by a controller of the electronic gaming system to receive value (physical currency or electronic currency) or return value (physical or electronic currency) to the user. The controller may cause the value input device or value output device to perform these functions upon receiving signals from the electronic wagering game indicating that currency debits or returns are to occur based on one or more in-game actions. For instance, the controller may be configured to detect, via the value input device, a physical item associated with a monetary value that establishes a monetary balance (e.g., a cash bill or a credit card). The controller may be further configured to receive, via the input device, a wager that is drawn from the monetary balance. At the conclusion of a game, the value output device, in response to a cashout input received via the input device, may dispense a payout from the monetary balance.

At least in some cases, the electronic gaming system may include a mobile electronic device (e.g., a smartphone, a tablet, a smartwatch, a laptop, or similar computing device). Such a mobile electronic device may include a housing that provides structural support for internal electronic components, including a controller, a value input device or value output device (e.g., a Bluetooth card reader or near-field communication (NFC) chip reader), or a touchscreen input device that a game player can use to provide inputs to the electronic gaming system.

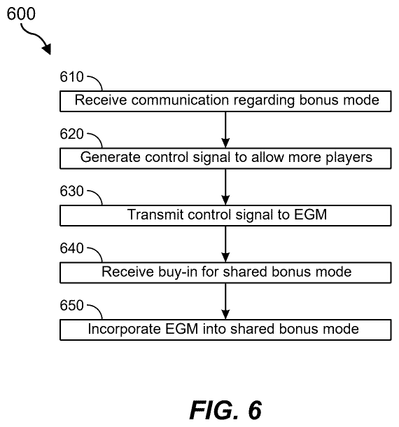

The controller of the electronic gaming system may be further configured to perform a method for generating and providing shared bonus features in Class II and Class III games, as well as notifying potential players where and for how long these shared bonus games are available. This method is generally shown in FIG. 6. FIG. 6 is a flow diagram of an exemplary computer-implemented method 600 for generating and providing shared bonus features and shared Class II and Class III bonus games, as well as notifying potential players where and for how long these shared bonus games are available. The steps shown in FIG. 6 may be performed by any suitable computer-executable code and/or computing system, including the electronic gaming machines illustrated in FIGS. 1-3.

In some examples, the steps shown in FIG. 6 may be performed by modules operating in an endpoint device such as an electronic gaming machine (EGM) (e.g., operating in a casino environment as described in connection with FIG. 1), or a personal user device (e.g., a smart phone, tablet, laptop, wearable device, and/or desktop), or by modules operating in a server (e.g., a backend computing device). In one example, each of the steps may represent an algorithm whose structure includes or is represented by multiple sub-steps, examples of which will be provided in greater detail below. In some examples, the steps may be executed by game processing backend system 314 as part of game processing architecture 300 as described in connection with FIG. 3.

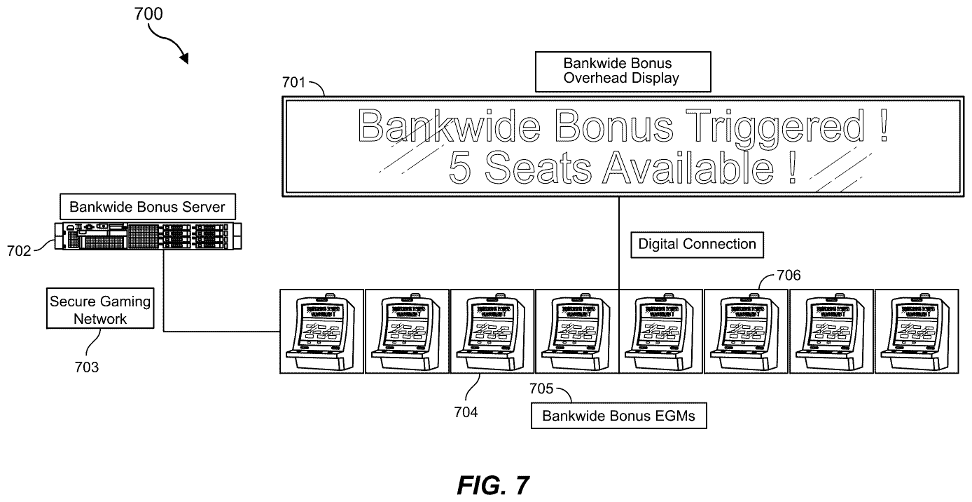

The method 600 includes, at step 610, receiving, via a secure communications network, a communication from a first EGM among a plurality of EGMs indicating that the first EGM has entered a shared bonus mode that is open to receiving further players to enhance a payout amount of the shared bonus mode. For example, as shown in embodiment 700 of FIG. 7, a bankwide bonus server 702 (or a controller that is part of or is embedded in the bankwide bonus server) may receive, via the secure gaming network 703, a communication from one of the EGMs (e.g., 704) in the bank of EGMs 705. The communication may indicate that the EGM 704 has entered a shared bonus mode that is open to receiving further players to enhance the payout amount of the shared bonus mode. It will be understood that the EGM 704 may be running any of a wide variety of different base games, and that any of these base games may include a shared bonus mode that allows other players to join and thereby enhance the payout or prize amount of the shared bonus mode. It will be further understood that the bank of EGMs 705 may include substantially any number of EGMs. Moreover, the EGMs may be located substantially anywhere within a casino (either immediately next to each other (as shown) or far apart from each other) or even across multiple casino buildings.

At step 620, method 600 may include generating a control signal for at least a second EGM of the plurality of EGMs to present an indication to other potential players that the shared bonus mode on the first EGM is open to receiving additional players for a limited amount of time. Thus, for instance, the bankwide bonus server 702 (or a controller therein) may generate a control signal for EGM 706 that is part of the bank of EGMs 705. The control signal may cause the second EGM 706 to present an indication to other potential players that the shared bonus mode on EGM 704 is open to receiving additional players for a limited amount of time. This limited amount of time may be configurable and may be on the order of 30 seconds, 45 seconds, one minute, two minutes, or some other configurable amount of time.

During that configurable amount of time, one or more of the other EGMs in the bank 705 may, upon receiving the control signal, present an indication to other potential players in the casino that the shared bonus mode is open to receiving additional players (e.g., showing a graphic with text indicating that the players can “Join Now,” along with a graphic illustrating a timer for X number of seconds or minutes). During that time, as the timer counts down, other users may join the shared, bankwide bonus mode. Users may join in the shared bonus mode in a variety of different ways, including buying in at a specified price, placing a wager one or more times, spinning and landing a specified symbol or set of symbols, or simply pressing a “Join” button that allows the user to join the shared bonus mode. Regardless of how the user joins, that user may be eligible to receive the shared bonus mode prize. Moreover, the value of the shared bonus mode prize may increase each time another user buys in or otherwise joins the shared bonus mode.

Method 600 next includes, at step 630, transmitting the generated control signal from the controller to at least the second EGM, such that the second EGM indicates to other players in the casino that the shared bonus mode is currently available. Accordingly, at least in some cases, the bankwide bonus server 702 of FIG. 7 may transmit, via the secure gaming network 703, a control signal to EGM 706 within the bank of EGMs 705. The control signal may direct or cause the second EGM (706) to display an indication that other players are able to join the shared bonus mode. In such cases, the EGM 706's user interface may change from a base game to a user interface that provides access to the shared bonus mode. The UI change may occur dynamically upon receiving and executing the control signal from the bankwide bonus server 702. Once the EGM 706 is in the shared bonus mode, the user at that EGM may begin buying in or otherwise playing the shared bonus game.

At step 640, the method 600 may include determining that the second EGM has received a buy-in from a player before the limited amount of time has expired and, at step 650, incorporating the second EGM into the shared bonus mode, such that players at both the first EGM and the second EGM are eligible to win the payout amount. Thus, in such cases, both the first EGM (e.g., 704) and the second EGM (e.g., 706) may participate in the same shared bonus game provided by the bankwide bonus server 702. Other EGMs in the bank of EGMs 705 may be joined by other users. In some cases, large numbers of EGMs may be providing the same shared bonus game (e.g., 25, 50, 100, 500, 1,000, etc.) at the same time. Each of these EGMs may display a timer that counts down and, at the end of which, the shared bonus game will start.

The shared bonus game may be provided on some or all of the EGMs in a given bank and may be provided on different banks throughout a casino or even across multiple casino buildings. At least in some cases, the bankwide bonus server 702 may control a display 701 above the one or more banks of EGMs that are providing the shared bonus game. The display 701 may indicate that the shared bonus game has been triggered. The display 701 may also indicate how many seats (e.g., EGMs) are still available to join and the amount of time until the shared bonus game begins. During this time, players can buy-in to the shared bonus game and play for a prize that increases in value with each player that joins.

In some cases, the payout amount (or simply “prize” herein) may be paid to a single player upon reaching an end condition in the shared bonus mode. In such cases, other players that joined the shared bonus mode are not winners and, if desired, can play a base game offered at that EGM. At least in some embodiments, the payout amount is based on how many players have bought in when the shared bonus mode ends. The payout amount may increase (e.g., linearly, exponentially, or at some other rate) each time a new player buys in to the shared bonus mode. The ultimate payout, then, at the end of the timer, is based on how many players have bought in when the shared bonus mode ends. The digital display 701 may encourage other players to join by displaying an increasing payout amount as other players join. In some cases, the initial player that triggered the shared bonus mode may win the prize in the shared bonus mode. In such cases, that player may win an additional amount that is not available to other players, since that player initially triggered the shared bonus mode. In other cases, a player that joined the shared bonus mode may win. In such cases, that player may win the payout amount that is available to all players that buy in after the shared bonus mode has been triggered.

In still other embodiments, at least part of the payout amount for the shared bonus mode may be paid to one player and part of the payout amount may be paid to another player upon reaching an end condition in the shared bonus mode. Thus, in such cases, the shared bonus mode prize is split among at least two players. These players may include the player that originally triggered the shared bonus mode and one or more other players, or the players may include solely players that joined the shared bonus mode after it was triggered. As noted above, the triggering of the shared bonus mode may occur in a variety of different ways, including landing on a specific value or set of values in a symbol position or series of symbol positions (e.g., a cash on reels (COR) value or a metamorphic or a series of particular symbols arranged in a preidentified pattern), winning one or more rounds in a base game, achieving a bingo or tic tac toe, or completing some other in-game task. Regardless of which type of trigger is used in any given situation, the shared bonus mode may be entered and may allow other players on other electronic gaming machines to join and increase the payout amount of the prize.

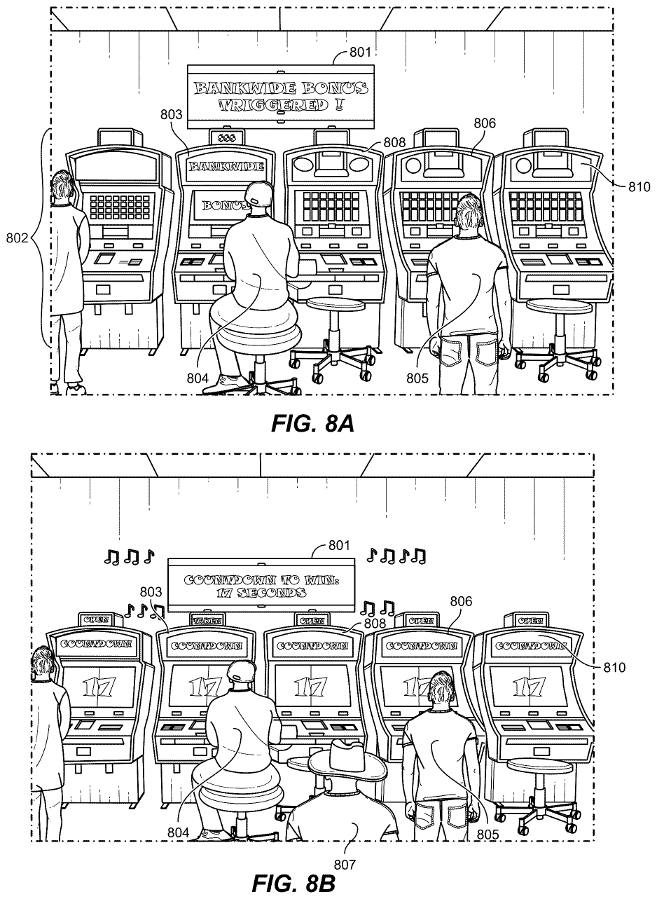

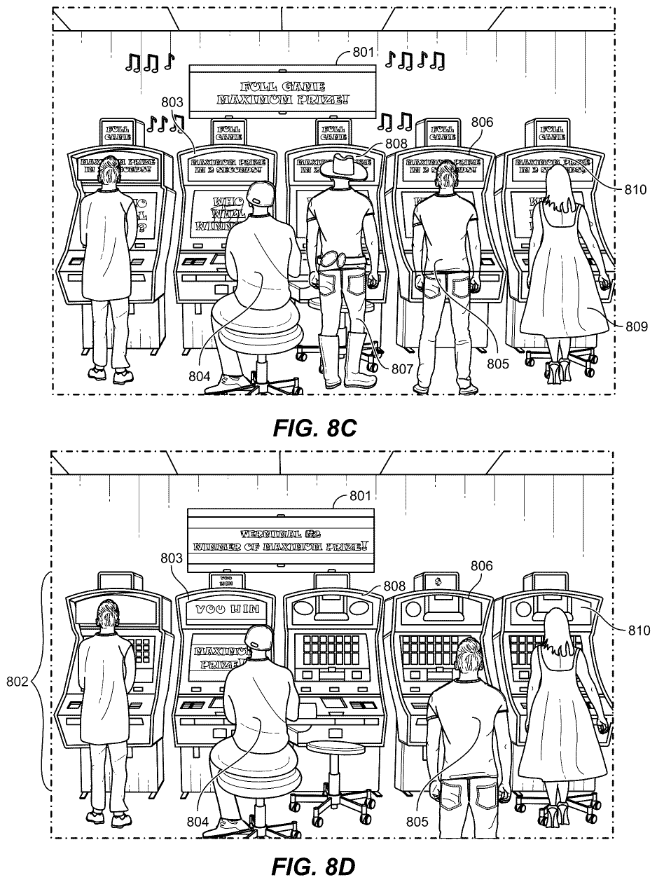

FIGS. 8A-8D illustrate an embodiment where a single player begins playing a base electronic wagering game, triggers the bankwide bonus mode, and sees other players joining the shared bonus mode. For instance, as shown in FIG. 8A, a user 804 may be playing a base electronic wagering game at EGM 803. The EGM 803 may be part of a bank of EGMs 802. As noted above, at least in some cases, the shared bonus mode may be provided across a single bank of EGMs or across multiple different banks of EGMs. These banks of EGMs may be located next to each other or near each other or may be located in different parts of the casino. Each of the EGMs involved in the shared bonus mode may be controlled by a single controller (e.g., part of bankwide bonus server 702 of FIG. 7) using control signals transmitted over a secure communications network 703.

Once the user 804 triggers the shared bonus mode at EGM 803, the other EGMs that are part of the shared bonus mode may be controlled to change from a base game to a user interface associated with the shared bonus mode. Thus, in FIG. 8A, other EGMs that are part of the bank of EGMs 802 (e.g., EGMs 806, 808, and 810) may change from a base electronic wagering game to a countdown timer shown in FIG. 8B. At such time, the shared bonus mode is open to a limited number of additional players at specific EGMs (e.g., 806, 808, and/or 810). This number of additional EGMs that are part of the shared bonus mode may be predetermined and may be fixed or may be changeable.

For instance, at least in some cases, the limited number of additional players may be dynamically expanded to include further players upon the occurrence of a specified condition. For example, if the bank of EGMs 802 quickly fills up with users (e.g., user 805 joins at EGM 806, user 807 joins at EGM 808, user 809 joins at EGM 810, etc. (as generally shown in FIG. 8C)) within a specified amount of time (e.g., five seconds, 10 seconds, 15 seconds, 30 seconds, etc.), then the shared bonus mode may be dynamically expanded to other EGMs and/or other banks of EGMs. In such cases, the additional players may raise the prize amount for the shared bonus mode even higher and may allow a larger number of players to have a chance at winning the shared bonus mode prize.

In some cases, as shown in FIG. 8D, the player that initially triggered the shared bonus mode (e.g., player 804) may win the shared bonus mode. In such cases, the payout amount of the shared bonus mode may be increased if the initial player that triggered the shared bonus mode is the winner of the shared bonus mode. The amount of the increase may vary based on how many additional players joined or may vary based on a fixed amount. In other cases, if a joining player wins the shared bonus mode, that player may receive the same amount that other, non-initiating (joining) players would win. As also shown in FIG. 8D, once the shared bonus mode prize has been awarded, the other EGMs in the bank may return to their base electronic wagering game.

At least in some embodiments, the payout amount for the shared bonus mode may increase incrementally each time a subsequent player buys in to the shared bonus mode on another EGM. In some cases, the total number of players in any one round of the shared bonus mode may be limited to a fixed number, while in other cases, the total number of players in a round of the shared bonus mode may dynamically increase (e.g., to a higher limited or unlimited number). In some cases, when players join the shared bonus mode by buying in, those players may only need to buy in once to be part of the shared bonus mode. In other cases, the joining players may need to provide subsequent buy-ins to stay eligible for the payout amount. These subsequent buy-ins may be required every 10 seconds, every 20 seconds, every 30 seconds, or at some other fixed or variable interval.

In such cases, if the joining player fails to provide the subsequent buy-ins (until the end condition for the shared bonus mode is met), that player may be released from the shared bonus mode and that EGM may return to the base game. In some embodiments, the shared bonus mode may present a decay meter that indicates a time by which the subsequent buy-ins are to be provided. That way, the joining user may be made aware of when they need to provide the subsequent buy-ins. Players that provide subsequent buy-ins may be eligible for a larger payout amount when the shared bonus mode prize is ultimately awarded. Still further, players that provide multiple subsequent buy-ins may be eligible for an even larger payout amount when the shared bonus mode prize is awarded.

During the course of the shared bonus mode, the bankwide bonus server 702 of FIG. 7 (or a controller therein) may send a control signal to a display mounted over or near one or more EGMs in the bank of EGMs 802 of FIG. 8A. In this embodiment, the digital display 801 is positioned above EGMs 803 and 808. The digital display 801 presents a notification indicating that the shared bonus mode has been triggered and is available to join. At least in some cases, the bankwide bonus server 702 may also transmit a control signal to another display mounted above at least a portion of another bank of EGMs to present the notification indicating that the shared bonus mode is available to join at that bank of EGMs. In this manner, the controller may control other digital displays to indicate that those banks of EGMs may also be used to join the shared bonus mode.

Still further, either the original digital display 801 or the second digital display may be updated, as generally shown in FIG. 8B, to show a countdown timer that indicates how long users have to buy in or otherwise join the shared bonus mode (e.g., 17 seconds in this case). Still further, as players join in, the shared bonus mode may reach its maximum number of players. If such occurs, the digital display may indicate that the shared bonus mode has reached full capacity and that the maximum value prize is available to those users that are playing the shared bonus mode. Once an end condition has been reached for the shared bonus mode, the digital display 801 may be updated to indicate which EGM terminal was the winner (EGM 803 in this case).

Within the shared bonus mode and/or within the base electronic wagering game, one or many different random numbers may be implemented to facilitate gameplay. At least in some cases where random numbers are generated and implemented within the electronic wagering game (e.g., using hardware random number generator 244 of FIG. 2A), the systems herein may carefully control or change the amount of randomness for each spin and/or for each reel in the spin to craft a specific outcome or range of outcomes. For example, in a 3×5 reel, such as reel 426(1) of FIG. 4, each of the reels may have multiple different value-bearing symbols. Each time the user spins the reels, the specific value-bearing symbols for each of the 15 locations in the array may be chosen based on a random number. In some cases, the degree of randomness may be the same for each reel or for each location within the array. In other cases, the degree or amount of randomness may be different for each reel or for each location in the array.

In some cases, for example, the degree of randomness for a given spin increases or decreases for each reel, from left to right. Thus, in some examples, the degree of randomness may start at a specified level (X) for the first reel on the left. For the second reel, the degree of randomness may decrease to X−Y, where Y is a numerical value above zero. For the third reel, the degree of randomness may decrease further to X−Y−Z, where Z is a numerical value above zero, and so on through the fifth reel. In that case, each progressive reel would have a decreased level of randomness, thus making some outcomes more likely in each subsequent reel. In such embodiments, game designers may specify which outcomes are more likely to occur within the reduced parameters for randomness.

In other cases, the degree of randomness may start at a specified level (X) for the first reel on the left and may increase for each reel to the right. Thus, for the second reel, the degree of randomness may increase to X+Y, where Y is a numerical value above zero. For the third reel, the degree of randomness may increase further to X+Y+Z, where Z is a numerical value above zero, and so on through the fifth reel. Thus, in such cases, each progressive reel would have an increased level of randomness, thus making some outcomes less likely in each subsequent reel. Accordingly, in these embodiments, game designers may specify which outcomes are less likely to occur within the increased parameters for randomness. In still further cases, some reels may have increased randomness, and some reels may have decreased randomness within the same spin. Moreover, in some cases, the randomness of each reel is independently determined for that reel and is not based on the results of any previous reels. In such cases, each reel value is randomly determined, independent of other reels.

Moreover, at least in some cases, the degree of randomness may change dynamically based on the previously selected random values. Thus, if certain value-bearing symbols appear in the first or second reels (e.g., CORs or scatter symbols), other value-bearing symbols may be more or less likely to appear in the third, fourth, and fifth reels according to the dynamic changes in randomness. In this manner, the controller, either alone or in conjunction with the hardware RNG, may carefully control the level or degree of randomness for each spin, and for each reel in that spin. The degree of randomness may provide parameters for the randomly selected values, ensuring that the randomness is above a specified value (X) but below a specified value (Y). These values may be predefined or may be established and changed dynamically over time as a particular game is played.

In some cases, for example, randomness may be controlled or bounded to increase the likelihood of CORs appearing on one or more of the reels. Or, the randomness may be controlled or bounded to increase the likelihood of wilds or metamorphic trigger symbols or scatter symbols appearing on one or more of the reels. Still further, randomness may be controlled to increase the likelihood of multipliers or wild multipliers (that multiply any line win that passes through the wild) appearing on one or more of the reels in an array, or increase the likelihood of three-of-a-kind wins, four-of-a-kind wins, five-of-a-kind wins, etc. Thus, at least in some embodiments, the degree or amount of randomness may be controlled to apply bounds within which the hardware RNG operates. This control of the randomness used in the game may be managed and carried out by the game controller. The controlled randomness may then be used to select value-bearing symbols for each reel and, when sufficient scatter symbols are present or when a metamorphic has reached a peak level, a bonus gameplay mode may be provided in which previously locked arrays become available for play, leading to potentially higher winnings for the player and greater player satisfaction with the game.

At least in some embodiments, this controlled randomness may be implemented to randomly select symbols during a reel spin for any of the plurality of reel spins in an electronic wagering game (e.g., the base game and/or the group bonus game). In some cases, for example, the electronic wagering game may determine a gaming outcome (e.g., a set of matching symbols) by first selecting a reel set from multiple available reel sets (e.g., the far-left reel set in FIG. 4 that includes block reels 426(1), 426(2), and 426(3)). Each reel set may include unique reel strips that introduce a high probability of specific events occurring based on underlying weights associated with each reel set. Then, based on a random number generated by an RNG in a controlled randomness implementation, a first reel set may be selected from the plurality of reel sets, where each reel set includes multiple reel strips (e.g., 5 reel strips, 15 reel strips, etc.). Then, based on a random number for each reel, a reel spin outcome is selected. Each reel set of the various reel sets has a differing probability that a specific reel spin outcome will occur.

In addition to the electronic gaming system described above, a computer-implemented method may be provided that includes: receiving, via a secure communications network, a communication from a first EGM indicating that the first EGM has entered a shared bonus mode that is open to receiving further players to enhance a payout amount of the shared bonus mode. The method also includes generating a control signal for at least a second EGM to present an indication to other potential players that the shared bonus mode on the first EGM is open to receiving additional players for a limited amount of time, transmitting the generated control signal from the controller to at least the second EGM, such that the second EGM indicates to other players that the shared bonus mode is currently available, determining that the second EGM has received a buy-in from a player before the limited amount of time has expired and incorporating the second EGM into the shared bonus mode, such that players at both the first EGM and the second EGM are eligible to win the payout amount.

A non-transitory computer-readable medium may also be provided that includes one or more computer-executable instructions that, when executed by at least one hardware processor of a computing device, cause the hardware processor to: receive, via a secure communications network, a communication from a first EGM indicating that the first EGM has entered a shared bonus mode that is open to receiving further players to enhance a payout amount of the shared bonus mode, generate a control signal for at least a second EGM to present an indication to other potential players that the shared bonus mode on the first EGM is open to receiving additional players for a limited amount of time, transmit the generated control signal from the controller to at least the second EGM, such that the second EGM indicates to other players that the shared bonus mode is currently available, determine that the second EGM has received a buy-in from a player before the limited amount of time has expired, and incorporate the second EGM into the shared bonus mode, such that players at both the first EGM and the second EGM are eligible to win the payout amount.

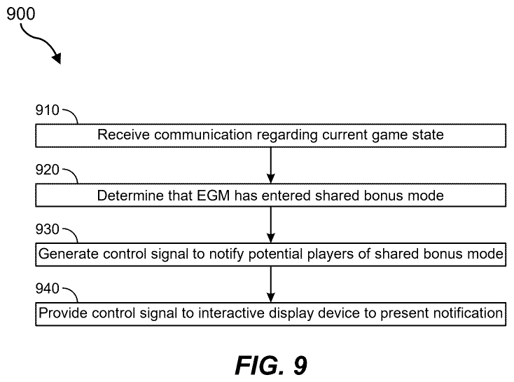

Turning now to FIG. 9, a method 900 is provided for notifying potential players where and for how long various shared bonus games are available. The steps shown in FIG. 9 may be performed by any suitable computer-executable code and/or computing system, including the electronic gaming machines illustrated in FIGS. 1-3 above. In some examples, the steps shown in FIG. 9 may be performed by modules operating in an endpoint device such as an electronic gaming machine (EGM) (e.g., operating in a casino environment as described in connection with FIG. 1), or a personal user device (e.g., a smart phone, tablet, laptop, wearable device, and/or desktop), or by modules operating in a server (e.g., a backend computing device). In one example, each of the steps may represent an algorithm whose structure includes or is represented by multiple sub-steps, examples of which will be provided in greater detail below. In some examples, the steps may be executed by game processing backend system 314 as part of game processing architecture 300 as described in connection with FIG. 3.

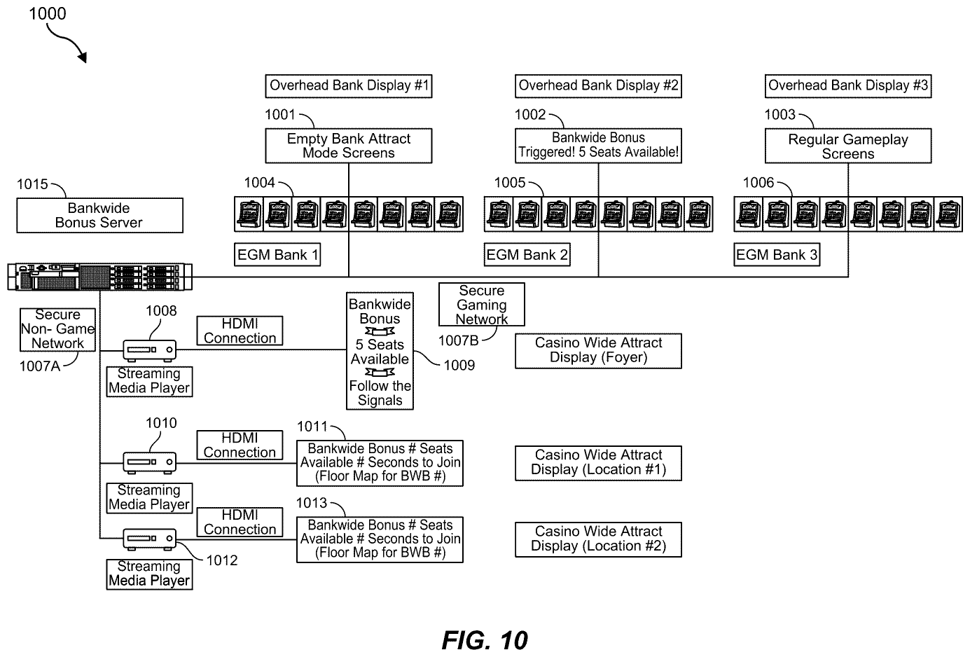

The method 900 includes, at step 910, receiving, via a secure communications network, a communication from at least one of a plurality of EGMs indicating a current game state of at least one EGM. For example, as generally illustrated in computer architecture 1000 of FIG. 10, a bankwide bonus server 1015 may receive, via a secure communications network (e.g., either the secure gaming network 1007B or the secure non-gaming network 1007A), a communication from one of the EGMs in bankwide bonus bank 1 (e.g., EGM 1004) indicating the current game state of that EGM. In some cases, the EGM 1004 may be in a “regular” or base game mode that provides a base electronic wagering game, either Class II or Class III. Or, in other cases, the EGM 1004 may be in a shared bonus mode with one or more other EGMs (e.g., in EGM bank 1, EGM bank 2, or EGM bank 3). Still further, the EGM may be in a standby state or some other operative state.

At step 920, method 900 may include determining that the current game state indicates that the at least one EGM has entered a shared bonus mode that is open to receiving further players to increase a payout amount of a prize offered in the shared bonus mode. As noted above, the shared bonus mode may be a bankwide bonus mode where some or all of the EGMs in a bank of EGMs may allow other users to join the shared bonus mode. While this shared bonus mode is open to receiving other users, an overhead bank display may indicate the current status of the bank of EGMs. For instance, the overhead bank display may indicate that the shared bonus mode is operable and that it is open to receiving additional players.

For example, overhead bank display #2 in FIG. 10 may indicate: “Bankwide Bonus Triggered! 5 seats available!” This may let users know that five EGMs (e.g., 1005) are available to join in the bankwide bonus (BWB) in EGM bank 2. In other cases, the overhead bank display may indicate that the bank of EGMs is currently offering regular or base gameplay (e.g., 1003), or the overhead bank display may show an empty bank attract mode screen (e.g., 1001) that shows nothing or shows that a base game or shared bonus mode may be played on one or more machines within that bank if initiated.

At step 930, method 900 may next include generating a control signal for the at least one interactive display device indicating that specific data are to be presented on the interactive display device to notify other potential players that the shared bonus mode on the EGM is open to receiving additional players. Then, at step 940, method 900 may include providing the generated control signal to the at least one interactive display device, so that the at least one interactive display device presents the data according to the control signal. As shown in FIG. 10, the bankwide bonus server 1015 may generate a control signal for overhead bank display #1, overhead bank display #2, and/or overhead bank display #3. Each of the overhead bank displays may be positioned over or near the corresponding bank of EGMs (EGM bank 1, EGM bank 2, or EGM bank 3). In other cases, the overhead bank displays may be positioned in other parts of a casino.

At least in some cases, those displays that are in other parts of the casino may be communicated with over a different type of secure network. For example, the bankwide bonus server 1015 may be connected to two (or more) different secure networks. In some cases, for instance, the bankwide bonus server 1015 may be communicatively connected to the secure gaming network 1007B. The secure gaming network 1007B may be set up and maintained at a specified minimum security level.

The specified minimum security level may prevent certain actions from occurring, such as account logins without two-factor authorization, or logins without a specific physical token, or data reading from a thumb drive or external hard drive, or logins from an unrecognized internet protocol (IP) address, logins after unapproved firewall changes, or other actions that would be deemed unsecure. The secure non-gaming network 1007A, on the other hand, may not be connected to gaming machines and, as such, may have a lower level of security. In some cases, the secure non-gaming network 1007A may only have access to casino wide attract displays (e.g., 1009, 1011, and/or 1013).

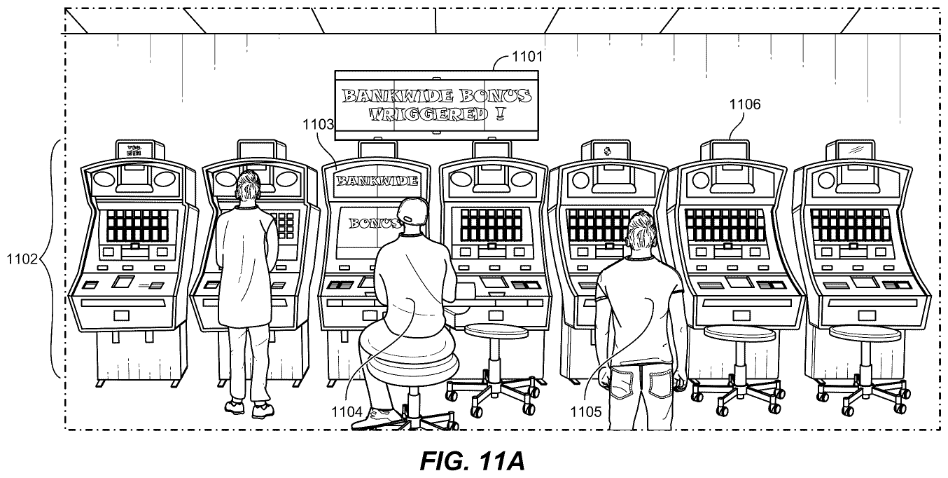

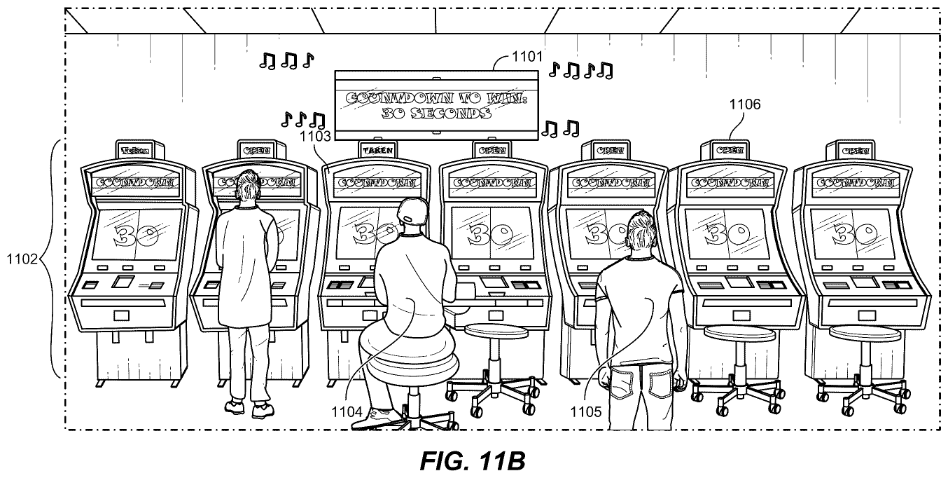

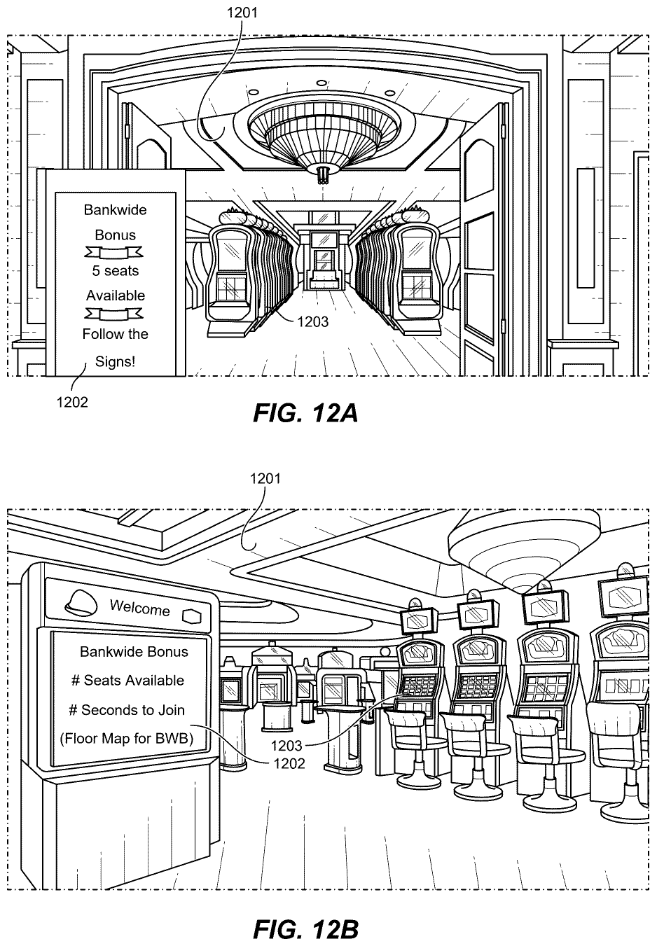

These “casino wide attract displays” may be configured to display specified information from the bankwide bonus server 1015 that is based on gaming data from the various banks of EGMs but is not received directly from the EGMs. The casino wide attract displays may, for example, display information indicating the number of seats that are currently available in a shared bonus mode (e.g., at display 1009). The casino wide attract displays may also show a timer indicating how long a user has to join a shared bonus mode, along with map information indicating where the machines with the shared bonus mode are currently located (e.g., displays 1011 and 1013). In some cases, the displays may be interactive, dynamically showing the user where to go to participate in a shared bonus mode, especially when the EGMs participating in a shared bonus mode may be constantly changing. This process will be described in greater detail below with regard to FIGS. 11A-12B.

FIG. 11A illustrates one embodiment of a system that includes multiple electronic gaming machines 1102. These EGMs may be connected via a secure communications network (e.g., 1007B of FIG. 10). The system may also include at least one interactive display device (e.g., 1101). The interactive display device may be connected to the EGMs via the secure communications network, or may be connected to a secure, non-gaming network (e.g., 1007A) that provides information regarding the current state of a bankwide bonus. Still further, the system may include a controller that is communicatively linked to the EGMs 1102 and to the interactive display device 1101.

The controller may be configured to receive, via the secure communications network, a communication from at least one of the EGMs 1102 (e.g., EGM 1103) indicating the current game state of that EGM. In the embodiment of FIG. 11A, the controller may determine that the current game state indicates that the EGM 1103 has entered a shared bonus mode that is open to receiving further players to increase a payout amount of a prize or other game outcome offered in the shared bonus mode. In response to determining that the EGM 1103 has entered a shared bonus mode, the controller may generate a control signal for the interactive display device 1101 indicating that specific data are to be presented to notify other potential players that the shared bonus mode on the EGM 1103 is open to receiving additional players. The controller may then provide the generated control signal to the interactive display device 1101, whereupon the interactive display device will present the data according to the control signal. Thus, in FIG. 11A, the interactive display device 1101 may present an indication that a bankwide bonus has been triggered by EGM 1103.

Then, as shown in FIG. 11B, the interactive display device 1101 may be updated to show an indication of time remaining before additional players are no longer able to be added to the shared bonus mode on the plurality of EGMs. In this example, when user 1104 triggered a bankwide bonus at EGM 1103, the bank of EGMs 1102 may each show a countdown of 30 seconds, indicating the time remaining before other players (e.g., 1105) are no longer able to be added to the bankwide bonus mode (e.g., at EGM 1106). At least in some cases, if an additional player joins the bankwide bonus, the timer may be increased by a predetermined amount (e.g., five seconds, 10 seconds, etc.). Thus, the bankwide bonus may be held open as additional players are joining. The interactive display device 1101 may also be updated to present an indication to players that may be further away that this bank of EGMs is currently in a bankwide bonus mode and that the bonus mode is open to receiving additional users for a limited amount of time.

In some cases, the interactive display device may provide an indication of a number of additional players that are able to be added to the shared bonus mode on the bank of EGMs. For example, in FIG. 12A, a casino 1201 may have multiple banks of EGMs (e.g., bank 1203). An interactive display device 1202 may indicate that a bankwide bonus has been triggered and may indicate which bank of EGMs has triggered the bonus mode. The interactive display device 1202 may include a pointer pointing the way to the specific bank of EGMs, or may identify the bank with a number or with an image, or may initiate a color matching scheme where the display device displays a color or set of colors that match the colors of the bank of EGMs that triggered the bonus mode. In other cases, the interactive display device 1202 may provide an indication to follow other display devices to the bank of EGMs. The interactive display device 1202 may include an indication of the number of seats available at that bank of EGMs (e.g., five seats available, as shown in interactive display device 1202). The display device may be updated dynamically as seats at the EGMs are populated with players that have joined the shared bonus mode.

In some embodiments, the interactive display device 1202 may provide an indication of a location of at least one EGM of the bank of EGMs that is open to adding at least one additional player to the shared bonus mode. In some cases, the interactive display device 1202 may be a mobile computing device that is carried by a user. In such cases, the mobile computing device may present a map showing the user's current location as determined by a global positioning system (GPS) signal, as well as the location of the bank of EGMs that is currently in bonus mode. The map may be interactive, allowing the user to zoom in or out, or to change to a different bank of EGMs, or to directionally guide the way dynamically as the user walks to the bank of EGMs. The user may see, on the interactive display device 1202, a real-time indication of the number of seats available at the bank of EGMs as well as a countdown timer indicating how long the user has to join the shared bonus mode. Thus, the interactive display device 1202 may provide not only step-by-step directional guidance to the location of the EGMs that are currently in bankwide bonus mode but may also indicate the current number of seats available and a timer by which time the shared game mode must be joined.

In some cases, the above information may change dynamically. For instance, one EGM that was open to adding an additional player to the shared bonus mode may no longer be available. In such cases, the controller may transmit updates to the interactive display device to provide directional guidance to the location of a different EGM in the bank of EGMs or may provide directional guidance to an entirely different bank of EGMs that is in bankwide bonus mode. Thus, the directional guidance may be dynamically updated and provided to the interactive display device 1202 on the fly as the shared bonus games become populated with other players. Upon reaching a destination bank of EGMs (as generally shown in FIG. 12B), the interactive display device 1202 may display the number of seats available at that bank of EGMs 1203, the number of seconds (or minutes) left to join the shared bonus mode, and/or may provide a floor map to other banks of EGMs that are currently in bonus mode or where the bankwide bonus mode may be triggered and subsequently joined.

In some embodiments, the interactive display device 1202 may be configured to provide specific advertisement information for certain electronic wagering games. For instance, if a base wagering game is providing access to a shared bonus mode, the interactive display device 1202 may be configured to show advertisement information for that base wagering game. The advertisement information may indicate the title of the game, an indication of which EGM banks are providing that game, an indication of directions to one or more of those EGM banks, an indication of the number of seats available at those EGMs, and other information. In some cases, as noted above, the interactive display device 1202 may be a touchscreen that can receive touch inputs from a user. In such cases, the interactive display device 1202 may receive one or more touch inputs from a user and then modify guidance information according to those inputs.

For instance, if the user saw that a base wagering game was being played on a particular bank of EGMs (e.g., 1203), the user could select an option that provided directions to that bank of EGMs. As the user walked closer to the EGMs, the directional guidance could be updated to show the user's current position relative to the EGMs, indicating which way the user should go to arrive at the desired EGMs. The interactive display device 1202 may provide an interactive map with real time GPS-based walking instructions to the specified zones. In some cases, the GPS-based walking instructions may be bolstered using a second radio signal (e.g., WiFi or Bluetooth or cellular, etc.). In such cases, the second radio signal may be used to determine the user's location in a building (e.g., relative to a WiFi router or repeater or cell tower). This measurement may be compared against the GPS signal to narrow the user's location with greater accuracy. That real time location of the user may then be shown in the interactive map and may be continually updated as the user moves toward the desired bank of EGMs.

At least in some embodiments, the directional guidance may include arrows that continually point to the desired bank of EGMs (regardless of how or where the user is walking) using compass and/or gyroscope readings. The directional guidance may also indicate the number of steps to the EGMs, or the approximate time needed to reach the machines. Still further, the interactive display device 1202 may present data that guides potential players to specific zones in a casino that may include EGMs playing the desired base game or that provide access to the shared bonus mode. The zone identifier may indicate which electronic wagering games are available in each specified zone. The directional guidance may then guide the potential players to those zones. In some cases, the zone identifier may specify which banks of EGMs are providing a Class III shared bonus mode. In other cases, the zone identifier may specify which banks of EGMs are providing a Class II shared bonus mode. Indeed, as will be explained further below, the embodiments herein may provide both Class III shared bonus modes (as described above) and Class II shared bonus modes (as described below).

In some embodiments, the interactive display device may present a quick-response (QR) code that can be scanned by a potential player's smartphone. The potential player's smartphone may use a camera and image-recognition functions to analyze the QR code and, upon performing the scanning, the smartphone may provide an interactive map with real time GPS walking instructions to a particular zone (e.g., a zone that is providing a shared bonus mode or a base game that provides access to a shared bonus mode). In some cases, a backend server may be configured to generate a control signal that is transmitted to the potential player's smartphone to trigger GUI generation and display on the smartphone.

In addition to the interactive map illustrating which EGMs are currently providing the shared bonus mode, the interactive map may also show which EGMs are occupied or are occupied above a specified threshold number (e.g., 8 out of 12 EGMs are occupied) or are occupied below a different specified threshold number (e.g., 3 of 12 EGMs are occupied). In such cases, the interactive map may be dynamically updated as EGMs in a particular zone become occupied as players join the shared bonus mode or become unoccupied as players leave the EGMs. In some embodiments, the interactive map may be dynamically updated according to player preferences for the percentage of EGMs that are currently occupied. For instance, some users may prefer to take part in games where the shared bonus mode is mostly full (e.g., 80% of the EGM bank is already occupied). Other users may prefer to take part in games where the shared bonus mode is mostly empty (e.g., 20% of the EGM bank is currently occupied, with 80% of the EGMs currently open to join).

In such cases, the interactive map may be controlled by the backend server to preferentially show EGM zones that the user would be most interested in, according to that user's preferences. Other user preferences may include an indication of which type of shared bonus mode is currently offered, which class of game is currently offered (e.g., Class II or Class III), or other gameplay preferences. Each of these player preferences may be considered and implemented by the backend server when generating the interactive map and when guiding the player to a particular zone. In this manner, each player may be uniquely and customizably guided to the gaming zone that will interest them the most at that point in time when they are looking to play.

In addition to the electronic gaming system described above, a computer-implemented method may be provided that includes: receiving, via a secure communications network, a communication from at least one of a plurality of EGMs indicating a current game state of the at least one EGM, determining that the current game state indicates that the at least one EGM has entered a shared bonus mode that is open to receiving further players to increase a payout amount of a prize offered in the shared bonus mode, generating a control signal for at least one interactive display device indicating that specific data are to be presented on the interactive display device to notify other potential players that the shared bonus mode on the EGM is open to receiving additional players, and providing the generated control signal to the at least one interactive display device, such that the at least one interactive display device presents the data according to the control signal.

A non-transitory computer-readable medium may also be provided that includes one or more computer-executable instructions that, when executed by at least one hardware processor of a computing device, cause the hardware processor to: receive, via a secure communications network, a communication from at least one of a plurality of EGMs indicating a current game state of the at least one EGM, determine that the current game state indicates that the at least one EGM has entered a shared bonus mode that is open to receiving further players to increase a payout amount of a prize offered in the shared bonus mode, generate a control signal for at least one interactive display device indicating that specific data are to be presented on the interactive display device to notify other potential players that the shared bonus mode on the EGM is open to receiving additional players, and provide the generated control signal to the at least one interactive display device, such that the at least one interactive display device presents the data according to the control signal.

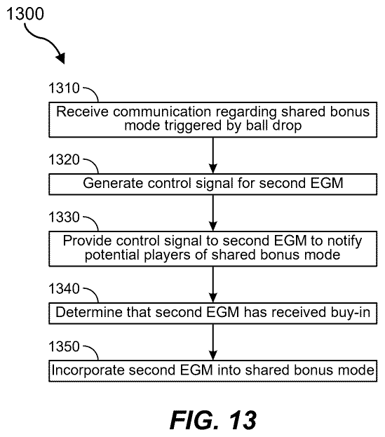

Turning now to FIG. 13, a method 1300 is provided for generating and providing shared bonus features and shared Class II bonus games. The steps shown in FIG. 13 may be performed by any suitable computer-executable code and/or computing system, including the electronic gaming machines illustrated in FIGS. 1-3 above. In some examples, the steps shown in FIG. 13 may be performed by modules operating in an endpoint device such as an electronic gaming machine (EGM) (e.g., operating in a casino environment as described in connection with FIG. 1), or a personal user device (e.g., a smart phone, tablet, laptop, wearable device, and/or desktop), or by modules operating in a server (e.g., a backend computing device). In one example, each of the steps may represent an algorithm whose structure includes or is represented by multiple sub-steps, examples of which will be provided in greater detail below. In some examples, the steps may be executed by game processing backend system 314 as part of game processing architecture 300 as described in connection with FIG. 3.

The method 1300 includes, at step 1310, receiving, via a secure communications network (e.g., secure non-gaming network 1007A of FIG. 10), a communication from an EGM (e.g., 1005) indicating a current game state of the EGM. For example, the bankwide bonus server 1015 may receive, via a secure communications network (e.g., either network 1007A or via the secure gaming network 1007B), a communication from one of the EGMs in bankwide bonus bank 2 (e.g., EGM 1005) indicating the current game state of that EGM. In some cases, the EGM 1005 may be in a “regular” or base game mode that provides a base electronic wagering game. In the embodiments of method 1300, the base electronic wagering game may be a Class II (bingo-based) game. The EGM 1005 may be in a shared bonus mode by itself or with one or more other banks of EGMs (e.g., in EGM bank 1, EGM bank 2, or EGM bank 3).

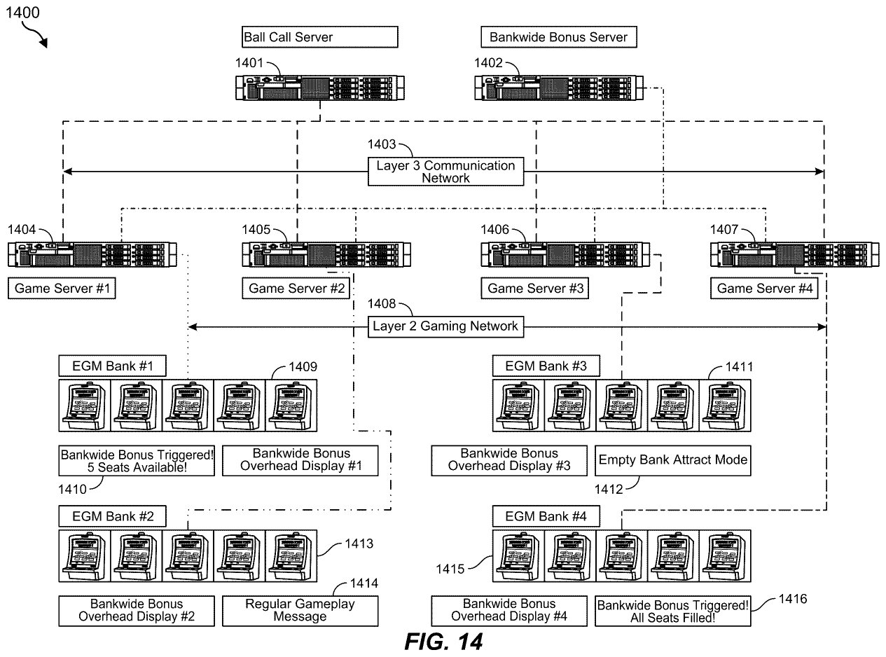

At least in some cases, the method 1300 may be carried out by a system that includes multiple EGMs arranged in different EGM banks. The system may include a wide area ball call server communicatively linked to the banks of EGMs. Still further, the system may include a bonus mode server communicatively linked to the bank(s) of EGMs, as well as a communications network that communicatively links the wide area ball call server to one or more Class II game servers (e.g., running bingo-based games or other chance-based games, such as keno), and a gaming network that communicatively links the Class II game servers to the plurality of EGM banks. The “wide area ball call server” (e.g., 1401 of FIG. 14) may refer to a backend server that is configured to generate random ball calls that are used in Class II, bingo-based games. For instance, the wide area ball call server 1401 may be used to generate random ball calls that are then used to play bingo or other chance-based games. The random ball calls may be used, for instance, by the bankwide bonus server 1402 to perform one or more of the steps in method 1300.

For example, at step 1320, method 1300 may include the bankwide bonus server 1402 receiving, via a secure communications network (e.g., layer 3 communications network 1403 and/or layer 2 gaming network 1408), a communication from a first electronic gaming machine (EGM) 1409 in EGM bank #1 indicating that EGM 1409 has entered a shared bonus mode that is open to receiving further players to enhance a payout amount of the shared bonus mode. The bankwide bonus server 1402 (or a controller embedded within the server) may then, at step 1330, generate a control signal for another EGM in EGM bank #1 to present an indication to other potential players that the shared bonus mode on the first EGM is open to receiving additional players for a limited amount of time.

At step 1340, the bankwide bonus server 1402 may transmit the generated control signal from the controller to one or more of the other EGMs in EGM bank #1, so that those EGMs indicate to other players that the shared bonus mode is currently available. At least in some cases, the bankwide bonus overhead display #1 may present in indication 1410 that the bankwide bonus has been triggered and that five seats are currently available at that EGM bank. The bankwide bonus server 1402, at step 1350, may then determine that at least one of the other EGMs in EGM bank #1 has received a buy-in from a player before the limited amount of time has expired. Then, upon making this determination, the bankwide bonus server 1402 may, at step 1360, incorporate the one or more other EGMs into the shared bonus mode, so that players at each of the EGMs in EGM bank #1 are eligible to win the payout amount. This scenario may be implemented on a single bank of EGMs or across multiple banks of EGMs.

For instance, computing environment 1400 of FIG. 14 illustrates four different banks of EGMs (EGM bank #1, EGM bank #2, EGM bank #3, and EGM bank #4). Each of these EGM banks may also have a corresponding overhead display. That display may present the current state of the EGM bank. For example, overhead display #3 may present an empty bank attract mode 1411 indicating that the EGM bank is currently empty and is available to play. The overhead display #2 may present a regular gameplay message 1414 indicating that the EGM bank is ready to provide the underlying base game through which the shared bonus mode is attainable. The overhead display #1 may present an indication 1410 that a shared bonus mode has been triggered and that a specified number of seats are open to join the shared bonus mode. Still further, overhead display #4 may present a message indicating that the shared bonus mode has been triggered and that all seats at that EGM are occupied. Other game states may also be presented on the overhead bank displays and/or directly on the EGM displays.

In at least some embodiments, the shared bonus mode may be entered upon reaching a triggering condition in a base electronic wagering game that is a Class II electronic wagering game. As noted above, Class II games may include bingo or other chance-based games. The Class II games may implement a ball call server 1401 that is not used in Class III games. The ball call server 1401 may use a random number generator to provide random ball calls that are used in the bingo-based games. The generated balls may include numbers that can then be used to fill in bingo cards within bingo games that are instantiated by various game servers (e.g., game servers 1404, 1405, 1406, and/or 1407). Once a winning pattern has occurred on the bingo card, the shared bonus mode may be triggered. This, then, allows others to join in the shared bonus mode using other EGMs on the same bank or on other EGMs that are connected via the layer 2 gaming network 1408 and/or the layer 3 communication network 1403.

In some cases, after the shared bonus mode has ended, the shared bonus mode prize may be paid to a single winner after an end condition to the base Class II electronic wagering game has been reached. Thus, regardless of how many players are playing the shared bonus mode, one player may win the entire shared bonus mode prize. In other cases, some of the shared bonus mode prize may be paid to a first player and some of the shared bonus mode prize may be paid to a second player upon reaching an end condition of the base Class II electronic wagering game. In such cases, two, three, four or more players may each receive a share of the shared bonus mode prize. The share may be split evenly between the multiple winners or may be paid disproportionately if the player that initially triggered the shared bonus mode was one of the winners. In that case, the player who initially triggered the shared bonus mode may receive a greater portion of the prize than the players who joined after the shared bonus mode had been entered.

Thus, the prize amount associated with the shared bonus mode prize may be increased when the player that triggered the shared bonus mode wins the shared bonus mode. In still other cases, the prize amount associated with the shared bonus mode prize may be based on how many players have bought in when the shared bonus mode ends. At least in some cases, the shared bonus mode prize may increase in value each time a new player joins the shared bonus mode. Additionally or alternatively, the prize amount associated with the shared bonus mode prize may be determined based on a Class II pay table. Thus, when the bankwide bonus server 1402 initiates payout to the shared bonus mode prize winner(s), the server may consult a Class II pay table to determine payout amounts that follow the table. Other factors may also affect the prize value, including prior wins, amount wagered, gaming establishment policies, etc.

In some embodiments, the base Class II electronic wagering game may be designed based on a specified theme (e.g., a certain animal, a sports team, a cartoon or movie character, a film franchise, etc.). In such cases, when the base Class II electronic wagering game goes into the shared bonus mode, the shared bonus mode may follow the theme of the base Class II electronic wagering game. Thus, if the base Class II electronic wagering game is themed after a professional sports team, the shared bonus mode may also be themed after that same professional sports team. In other cases, the opposite may be true. The base Class II electronic wagering game may be designed based on a specified theme, and the shared bonus mode may follow a different theme than that of the base Class II electronic wagering game. This option may be configurable and may be different in different casinos or in different parts of the same casino.

In some cases, one or more banks of EGMs that provide a base Class II electronic wagering game may be added to a group of EGMs that provide the shared bonus mode. In some cases, the new EGMs may be added dynamically while a shared bonus mode is being provided. For instance, as noted above, a casino may have many different banks of EGMs that are located in different parts of the casino. Each of these EGMs may be controlled by the ball call server 1401 using control signals transmitted over the secure communications network 1403. In some cases, the bankwide Class II server may serve a local area or a wide area. For example, a Class II server serving a local area may provide a bankwide bonus across one or more EGM banks within a casino, and a wide area server may provide a bankwide bonus across an entire casino or across multiple casinos. The bankwide Class II server may be connected to other casinos or other banks within the same casino via wireless (e.g., WiFi) internet connections and, at least in some cases, may connect to individual devices (e.g., mobile electronic devices capable of presenting Class II games).

In cases where an EGM bank (e.g., bank #1) is currently presenting the shared bonus mode, the ball call server 1401 may also allow EGM banks #2-4 to join the shared bonus mode. The ball call server (and/or the bankwide bonus server 1402) may then communicate with the individual game servers 1405-1407 to allow the shared bonus mode to be presented on those EGMs (e.g., 1411, 1413, and/or 1415). Thus, in this manner, individual EGMs or entire banks of EGMs may be dynamically added to the group of EGMs that are providing the shared bonus mode, as controlled by the ball call server 1401 and/or the bankwide bonus server 1402.

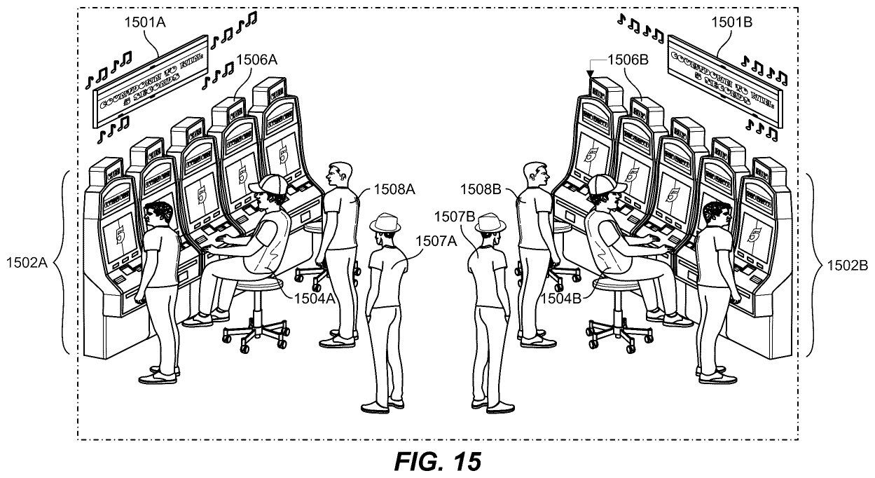

In some embodiments, when the shared bonus mode is triggered, the shared bonus mode may be open to a limited, specified number of additional players. For instance, once an initial user has triggered the shared bonus mode, that shared bonus mode may be open to three, five, ten, twenty, or some other limited number of additional players. Alternatively, at least in some cases, the shared bonus mode may have no maximum number of players and may dynamically expand to include further players. For instance, as shown in FIG. 15, player 1504A at EGM bank 1502A may play a base Class II electronic wagering game and may trigger a shared bonus mode. The overhead digital display 1501A may indicate that the shared bonus mode has been triggered and that other users near EGM bank 1502A (e.g., users 1504A or 1507A) can join the shared bonus mode. The EGMs in bank 1502A (e.g., EGM 1506A), as well as the digital display 1501A, may present countdown timers indicating how long the potential players have to join the shared bonus mode.

In some cases, if multiple players join the shared bonus mode on bank 1502A, the underlying system may dynamically expand the shared bonus mode to one or more other banks of EGMs. For example, the shared bonus mode may be dynamically added to EGM bank 1502B. This bank may be physically located near the initial bank of EGMs that triggered the shared bonus mode, or the new bank may be located further away. The dynamically joined bank of EGMs 1502B may also present a countdown time that is in sync with the first bank of EGMs. Other potential players (e.g., 1504B, 1506B, 1507B, etc.) may join any of the EGMs (e.g., 1506B) that are not already occupied. This process may continue across many different banks of EGMs until a maximum number is reached for the game or until the countdown timer runs out.

In some scenarios, the dynamic expansion to other banks of EGMs may occur when one or more specified conditions have been confirmed. These conditions may include a minimum number of players, a minimum amount of money wagered, or other specified conditions. Dynamically expanding shared prize modes may allow the prize amount to increase to a very large amount, especially in cases where the shared bonus mode prize amount increases incrementally each time a subsequent player buys in to the shared bonus mode on another EGM. Still further, in cases where players that subsequently join the dynamically expanding shared bonus mode continue to provide subsequent buy-ins while the countdown timer is running, the prize amount may increase even further. In this manner, the shared bonus mode may grow and expand across different EGMs and different banks of EGMs and may allow the shared bonus mode prize value to increase much higher than it would normally.

At least in some cases, as noted above, the amount of a Class II bankwide bonus may be tied to the number of people that join the bankwide bonus mode. While the bankwide bonus mode is open, additional players may join. In such cases, for each new player that joins the bonus, the total amount of the bonus may increase in a linear or non-linear manner. The amount of the prize may be based on a predetermined return to player (RTP) of the base game combined with the bankwide bonus. For example, a player may play the base game and trigger the bankwide bonus mode as a result of landing a specific bingo pattern. That triggering bingo pattern may have an RTP value assigned to it (e.g., 93%), while the bankwide bonus may have an additional RTP assigned to it (e.g., 2%), for a total of 95% (or some other predetermined RTP minimum value).

At least in some cases, the RTP itself may change based on the number of players. For instance, the RTP may increase an additional 0.25% for each player that joins the bonus mode. In cases where the maximum number of players to join the bonus mode is eight, for example, the RTP may increase 0.25% for each player, totaling an additional 2% for that instance of the bonus mode. In some cases, the bankwide bonus may specify a winning pattern for the base game (e.g., hit four corners pattern on a bingo card, or achieve some other designated pattern). Once someone hits the designated pattern, the bankwide bonus will be opened and the prize value may increase each time another player joins. In some cases, as noted above, the bonus may be higher for the player that triggered the bonus.

Still further, the bonus amount may be higher for players that stay and keep playing at the EGM bank after a bonus has been won. For instance, if a player joins a bonus mode, doesn't win that bonus mode but stays at that EGM bank starts playing the base game, if that player then triggers the bonus or merely plays in the next bankwide bonus round, that player may have a higher bonus multiplier if they then win that round of the bonus mode (e.g., 1.25× or 1.5× winnings, etc.). Moreover, in some cases, high, medium, or low bonus amounts may be paid based on different bingo patterns. For instance, in some cases, an exact pattern needs to be hit to win the bankwide bonus. In other cases, players can hit patterns that are near the specified pattern. In such cases, if the user is fairly close, but not exact, they may win a smaller prize. If the user's bingo pattern is closer, but not exact, they may win a medium prize, and if the user's bingo pattern is very close to the winning pattern, but not exact, they may win a high prize amount.

In some embodiments, the game servers may establish ball limits for the high, medium, and low prizes. For instance, the game server may specify that certain bingo patterns need to be hit within 30 balls or within 40 balls, or within 70 balls (e.g., blackout). In some cases, the winning bingo patterns may be instant win patterns that immediately trigger the bankwide bonus or immediately win the bonus round. In such cases, an upper limit may be established where the instant win must come within the first 30 balls or within 40 balls, for example. If a fewer number players are playing that round, the number of balls may be increased to increase the chances of the instant win happening or the high/medium prize being awarded, while if more players are playing in that round of the bonus mode, the maximum number of balls may be reduced since more players may automatically lead to an increased chance of the instant win happening or the high/medium prize being awarded. Accordingly, the closeness to the winning pattern for a player's bingo card may scale with the number of players, thereby making it harder or easier to hit the winning pattern or achieving a pattern that is close to the winning pattern.

In some cases, for embodiments that involve a fixed pattern or a fixed number of balls that are required to trigger the bankwide bonus and/or the bonus award, the duration of the time to trigger the bonus and/or the duration of play during the bonus mode before triggering the bonus award may be too long for a small group of players and may be too short for a large group of players. As such, the likelihood of triggering the bankwide bonus or winning the bankwide bonus by hitting a certain pattern may scale with the number of players participating in the bonus mode. For example, if a fewer number of players were participating in the bonus round, the bonus pattern may scale so that the pattern is easier to hit (e.g., by allowing inexact patterns to win). Moreover, as the number of players increases, the bonus pattern may be more difficult to hit (e.g., by only allowing patterns that are closer to the winning pattern to win). Accordingly, at least in some examples, the time between triggering the bonus might have a target of approximately every 20 minutes, and the duration of play of the bonus mode before triggering the award might be targeted at five minutes, regardless of the number of players participating. The embodiments herein may balance the duration of the bonus to achieve these target values by scaling the bonus patterns so that they are easier or harder to hit to meet the target duration values.

When the Class II bingo games described above are being played, the game servers (as opposed to the EGMs themselves) may create the pay tables, create the bingo cards, perform the evaluation of the cards against the ball call, decide when credits are to be awarded, and then award the credits to the player. Accordingly, the bankwide bonus mode may be applied within game servers without any need to update pay tables on individual EGMs. At least in some cases, the game servers may place the EGMs in a bankwide bonus mode to allow that bank of EGMs to play in the bankwide bonus. In other embodiments, the game servers may initiate a promotional mode or a tournament mode or other type of bonus mode. In a promotional mode, the EGMs may indicate that every two hours, a $500 prize may be awarded by that bank of EGMs. The game server will then ensure that the $500 is paid out every two hours. In a tournament mode, specific rules to rising through the ranks of the tournament may be applied by the game servers, the results of which are transmitted to the EGMs.

At least in some cases, players may buy in to the bankwide bonus with same amount of money as the original player that won the base game bought in with. In other cases, players may be able to buy in to the bonus mode for a lesser amount but may only be eligible to win a correspondingly lesser amount. Moreover, some bankwide bonus instances may result in a single winner, while other bankwide bonus instances may result in multiple winners or games where everyone that plays is a winner. For instance, some bankwide bonus games may pay the winning player 80% of the prize value, while sharing the other 20% with the remaining bankwide bonus players. Other percentages are, of course, possible. In some cases, players that have bought in at a higher amount or at a higher rate or have spun an increased number of times may get a higher share of the overall win or a higher share of the 20% consolation prize. In some embodiments, if a user has spun multiple times during the bankwide bonus, any credits that the user has built up may carry over to next base game or to the next bankwide bonus game. Such carryover may act as an incentive to keep players at that bank of EGMs. At least in some cases, credits may carry over across multiple rounds of base game and bonus game.

In addition to the electronic gaming system described above, a computer-implemented method may be provided that includes: receiving, via a gaming network, a communication from a first EGM of a first bank of EGMs indicating that the first EGM has entered a bonus mode according to a ball drop generated by a ball call server, wherein the bonus mode is open to receiving additional players to increase a prize amount of a shared bonus mode prize, generating a control signal for at least a second EGM of the plurality of EGMs to present an indication to other potential players that the shared bonus mode on the first EGM is open to receiving additional players for a limited amount of time, providing the generated control signal to at least the second EGM, such that the second EGM notifies other potential players that the shared bonus mode is currently available, determining that the second EGM has received a buy-in from a player before the limited amount of time has expired, and incorporating the second EGM into the shared bonus mode, such that players at both the first EGM and the second EGM are eligible to win the shared bonus mode prize.

A non-transitory computer-readable medium may also be provided that includes one or more computer-executable instructions that, when executed by at least one hardware processor of a computing device, cause the hardware processor to: receive, via a gaming network, a communication from a first EGM of a first bank of EGMs indicating that the first EGM has entered a bonus mode according to a ball drop generated by a ball call server, wherein the bonus mode is open to receiving additional players to increase a prize amount of a shared bonus mode prize, generate a control signal for at least a second EGM of the plurality of EGMs to present an indication to other potential players that the shared bonus mode on the first EGM is open to receiving additional players for a limited amount of time, provide the generated control signal to at least the second EGM, such that the second EGM notifies other potential players that the shared bonus mode is currently available, determine that the second EGM has received a buy-in from a player before the limited amount of time has expired, and incorporate the second EGM into the shared bonus mode, such that players at both the first EGM and the second EGM are eligible to win the shared bonus mode prize.

In some examples, one or more of the devices and/or subsystems may be employed in any number of software, firmware, and/or hardware configurations. For example, one or more of the embodiments disclosed herein are encoded as a computer program (also referred to as computer software, software applications, computer-readable instructions, or computer control logic) on a computer-readable medium. The term “computer-readable medium,” as used herein, refers to any form of device, carrier, or medium capable of storing or carrying computer-executable and/or computer-readable instructions. Examples of computer-readable media include, without limitation, transmission-type media, such as carrier waves, and non-transitory-type media, such as magnetic-storage media (e.g., hard disk drives, tape drives, etc.), optical-storage media (e.g., Compact Disks (CDs), Digital Video Disks (DVDs), and BLU-RAY disks), electronic-storage media (e.g., solid-state drives and flash media), and other digital storage systems.

A computer-readable medium containing a computer program may be loaded into one of the devices and/or subsystems. All or a portion of the computer program stored on the computer-readable medium is then stored in memory and/or a storage device. When executed by a physical processor, a computer program loaded into the memory causes the physical processor to perform and/or be a means for performing the functions of one or more of the embodiments described and/or illustrated herein. Additionally or alternatively, one or more of the embodiments described and/or illustrated herein are implemented in firmware and/or hardware. For example, one or more of the devices and/or subsystems herein may be configured as an ASIC adapted to implement one or more of the embodiments disclosed herein.

As detailed above, the computing devices and systems described and/or illustrated herein broadly represent any type or form of computing device or system capable of executing computer-readable instructions, such as those contained within the modules described herein. In their most basic configuration, these computing device(s) may each include at least one memory device and at least one physical processor.

In some examples, the term “memory device” generally refers to any type or form of volatile or non-volatile storage device or medium capable of storing data and/or computer-readable instructions. In one example, a memory device may store, load, and/or maintain one or more of the modules described herein. Examples of memory devices include, without limitation, Random Access Memory (RAM), Read Only Memory (ROM), flash memory, Hard Disk Drives (HDDs), Solid-State Drives (SSDs), optical disk drives, caches, variations or combinations of one or more of the same, or any other suitable storage memory.

In some examples, the term “physical processor” generally refers to any type or form of hardware-implemented processing unit capable of interpreting and/or executing computer-readable instructions. In one example, a physical processor may access and/or modify one or more modules stored in the above-described memory device. Examples of physical processors include, without limitation, microprocessors, microcontrollers, Central Processing Units (CPUs), Field-Programmable Gate Arrays (FPGAs) that implement softcore processors, Application-Specific Integrated Circuits (ASICs), portions of one or more of the same, variations or combinations of one or more of the same, or any other suitable physical processor.

The preceding description has been provided to enable others skilled in the art to best utilize various aspects of the exemplary embodiments disclosed herein. This exemplary description is not intended to be exhaustive or to be limited to any precise form disclosed. Many modifications and variations are possible without departing from the spirit and scope of the present disclosure. The embodiments disclosed herein should be considered in all respects illustrative and not restrictive. Reference may be made to any claims appended hereto and their equivalents in determining the scope of the present disclosure.

Unless otherwise noted, the terms “connected to” and “coupled to” (and their derivatives), as used in the specification and/or claims, are to be construed as permitting both direct and indirect (i.e., via other elements or components) connection. In addition, the terms “a” or “an,” as used in the specification and/or claims, are to be construed as meaning “at least one of.” Finally, for ease of use, the terms “including” and “having” (and their derivatives), as used in the specification and/or claims, are interchangeable with and have the same meaning as the word “comprising.”

What is claimed is:

1. A system comprising:
a plurality of electronic gaming machines (EGMs) arranged in a plurality of EGM banks;
a wide area ball call server communicatively linked to the plurality of EGMs;
a bonus mode server communicatively linked to the plurality of EGMs;
a communications network that communicatively links the wide area ball call server to a plurality of Class II game servers; and
a gaming network that communicatively links the Class II game servers to the plurality of EGM banks, wherein the bonus mode server:
receives, via the gaming network, a communication from a first EGM of a first bank of EGMs indicating that the first EGM has entered a bonus mode according to a ball drop generated by the wide area ball call server, wherein the bonus mode is open to receiving additional players to increase a prize amount of a shared bonus mode prize;
generates a control signal for at least a second EGM of the plurality of EGMs to present an indication to other potential players that the shared bonus mode on the first EGM is open to receiving additional players for a limited amount of time;
provides the generated control signal to at least the second EGM, such that the second EGM notifies other potential players that the shared bonus mode is currently available;
determines that the second EGM has received a buy-in from a player before the limited amount of time has expired; and
incorporates the second EGM into the shared bonus mode, such that players at both the first EGM and the second EGM are eligible to win the shared bonus mode prize.

2. The system of claim 1, wherein the shared bonus mode is entered upon reaching a triggering condition in a base Class II electronic wagering game.

3. The system of claim 2, wherein the shared bonus mode prize is paid to a single winner after an end condition to the base Class II electronic wagering game has been reached.

4. The system of claim 2, wherein at least part of the shared bonus mode prize is paid to a first player and at least part of the shared bonus mode prize is paid to a second player upon reaching an end condition to the base Class II electronic wagering game.

5. The system of claim 2, wherein the base Class II electronic wagering game is designed based on a specified theme, and wherein the shared bonus mode follows the specified theme of the base Class II electronic wagering game.

6. The system of claim 2, wherein the base Class II electronic wagering game is designed based on a specified theme, and wherein the shared bonus mode follows a different theme than the specified theme of the base Class II electronic wagering game.

7. The system of claim 1, wherein a prize amount associated with the shared bonus mode prize is increased when a player that triggered the shared bonus mode wins the shared bonus mode.

8. The system of claim 1, wherein a prize amount associated with the shared bonus mode prize is based on how many players have bought in when the shared bonus mode ends.

9. The system of claim 1, wherein a prize amount associated with the shared bonus mode prize is determined based on a Class II pay table.

10. The system of claim 1, wherein the plurality of EGMs includes multiple different banks of EGMs.

11. The system of claim 10, wherein the different banks of EGMs are located in different parts of a casino.

12. The system of claim 11, wherein each of the EGMs in the plurality of EGMs is controlled by the wide area ball call server using control signals transmitted over the communications network.

13. The system of claim 11, wherein one or more EGMs are dynamically added to at least one of the banks of EGMs, and wherein the added EGMs are controlled by the wide area ball call server.

14. The system of claim 1, wherein the shared bonus mode is open to a limited, specified number of additional players.

15. The system of claim 14, wherein the limited number of additional players is dynamically expanded to include further players upon the occurrence of one or more specified conditions.

16. The system of claim 1, wherein a prize amount of the shared bonus mode prize increases incrementally each time a subsequent player buys in to the shared bonus mode on another EGM.

17. The system of claim 1, wherein players that subsequently join the shared bonus mode stay eligible for the prize amount upon providing one or more subsequent buy-ins.

18. The system of claim 11, further comprising sending a control signal to a display mounted above at least a portion of the first EGM to present a notification indicating that the shared bonus mode is available to join, wherein the notification provides a timer indicating a time by which players are to buy in in order to participate in the shared bonus mode.

19. A computer-implemented method comprising:
receiving, via a gaming network, a communication from a first EGM of a plurality of EGMs indicating that the first EGM has entered a bonus mode according to a ball drop generated by a wide area ball call server, wherein the bonus mode is open to receiving additional players to increase a prize amount of a shared bonus mode prize;
generating a control signal for at least a second EGM of the plurality of EGMs to present an indication to other potential players that the shared bonus mode on the first EGM is open to receiving additional players for a limited amount of time;
providing the generated control signal to at least the second EGM, such that the second EGM notifies other potential players that the shared bonus mode is currently available;
determining that the second EGM has received a buy-in from a player before the limited amount of time has expired; and
incorporating the second EGM into the shared bonus mode, such that players at both the first EGM and the second EGM are eligible to win the shared bonus mode prize.

20. A non-transitory computer-readable medium comprising one or more computer-executable instructions that, when executed by at least one hardware processor of a computing device, cause the hardware processor to:
receive, via a gaming network, a communication from a first EGM of a plurality of EGMs indicating that the first EGM has entered a bonus mode according to a ball drop generated by a wide area ball call server, wherein the bonus mode is open to receiving additional players to increase a prize amount of a shared bonus mode prize;
generate a control signal for at least a second EGM of the plurality of EGMs to present an indication to other potential players that the shared bonus mode on the first EGM is open to receiving additional players for a limited amount of time;
provide the generated control signal to at least the second EGM, such that the second EGM notifies other potential players that the shared bonus mode is currently available;
determine that the second EGM has received a buy-in from a player before the limited amount of time has expired; and
incorporate the second EGM into the shared bonus mode, such that players at both the first EGM and the second EGM are eligible to win the shared bonus mode prize.
